(19) United States
(12) Patent Application Publication
(10) Pub. No.: US 2026/0352290 A1
(43) Pub. Date: Nov. 5, 2026

(54) METHODS AND APPARATUSES FOR CHANNEL STATE INFORMATION COMPRESSION AND DECOMPRESSION

(71) Applicant: TOYOTA JIDOSHA KABUSHIKI KAISHA, Toyota-shi, Aichi-ken (JP)

(72) Inventor: Shao-Yu LIEN, Tainan City (TW)

(73) Assignee: TOYOTA JIDOSHA KABUSHIKI KAISHA, Toyota-shi, Aichi-ken (JP)

(21) Appl. No.: 19/486,777

(22) PCT Filed: May 21, 2023
(86) PCT No.: PCT/JP2024/018731

§ 371 Date: Nov. 21, 2025

Related U.S. Application Data
(60) Provisional application No. 63/504,054, filed on May 24, 2023.

(51) Int. Cl. H04B 7/06; H04L 41/16

(52) U.S. Cl. CPC H04B 7/0626; H04L 41/16

(57) ABSTRACT

Disclosed are methods, apparatuses, and systems for a first node for a communication. The method includes: receiving, from a second node, compressed channel state information (CSI) generated based on one or more current models, the one or more current models being one or more artificial intelligence or machine learning (AI/ML) based models and determined based on one or more current datasets; determining whether the one or more current models are feasible for at least one of: CSI generation or CSI reconstruction; obtaining, in response to a determination that the one or more current models are not feasible for at least one of the CSI generation or the CSI reconstruction, one or more additional models for generation of updated compressed CSI; and transmitting, to the second node, the one or more additional models.

### CROSS-REFERENCE TO RELATED PATENT APPLICATION

This application is a national phase of PCT/JP2024/018731, filed on May 21, 2024, which claims the benefit of U.S. Provisional Application No. 63/504,054, filed on May 24, 2023, entitled “CSI Feedback Compression in 5G NR with Off-line Training,” the entirety of each of which is incorporated by reference herein.

### TECHNICAL FIELD

Apparatuses and methods consistent with the present disclosure relate generally to communications, more specifically, methods, systems, and devices for generating compressed channel state information in communications.

### BACKGROUND ART

Monitoring downlink/uplink channel condition is important for ensuring communication quality. To estimate a downlink channel condition, a network may transmit reference signals to a user equipment (UE). Upon receiving the reference signals, the UE may estimate the downlink channel condition based on measurements of the received reference signals. The UE may further inform the network about the estimated downlink channel condition by sending channel state information (CSI) to the network. Generally, the dimension of the channel condition is high and therefore, it is difficult to precisely describe the channel condition. This challenge can be addressed by providing compressed CSI that allows for use of a fewer number of bits to report the channel condition.

The process of generating compressed CSI may involve model training. The model training may be performed by the UE, or the network, or both. For an off-line model training, in which labeled examples and/or labeled datasets are available for the model training, there can be at least two challenges. The first challenge is determining which node (the UE or the network or both) should trigger the model training. At an initial stage, initial models can be deployed to the UE and the network for CSI compression and CSI reconstruction. However, communication environment changes over time, and this change may degrade performance of the CSI compression. When performance of the CSI compression degrades, new models should be trained and deployed to replace the old models. To this end, the UE or the network or both should identify infeasibility of a current model and trigger a new model training. Selecting which node (the UE or the network or both) to train the new model directly affects overall performance of the channel condition estimation. The second challenge in generating compressed CSI is determining the procedures to support the model training. Both the UE and the network may have capabilities to perform the model training. Also, the network may include a base station and a core network. To enable these nodes (the UE, the base station, or the core network) to perform the model training, different procedures are needed. Selecting the particular procedure for the model training also affects overall performance of the channel condition estimation. Systems and methods that can flexibly and efficiently select a node and/or determine a procedure to perform model training in different situations are desired.

### SUMMARY OF INVENTION

According to some embodiments of the present disclosure, there is provided a first node for a communication. The first node includes a memory storing an instruction; and a processor configured to execute the instruction stored in the memory to: receive, from a second node, compressed CSI generated based on one or more current models, the one or more current models being one or more artificial intelligence (AI) or machine learning (ML) based models and determined based on one or more current datasets; determine whether the one or more current models are feasible for at least one of: compressed CSI generation or compressed CSI reconstruction (hereinafter in the present disclosure and claims “compressed” will be omitted when referring to CSI generation and/or CSI reconstruction, but it should be understood that “CSI generation” refers to compressed CSI generation and “CSI reconstruction” refers to compressed CSI reconstruction); obtain, in response to a determination that the one or more current models are not feasible for at least one of the CSI generation or the CSI reconstruction, one or more additional models for generation of updated compressed CSI; and transmit, to the second node, the one or more additional models.

According to some embodiments of the present disclosure, there is provided a second node for a communication. The second node includes a memory storing an instruction; and a processor configured to execute the instruction stored in the memory to: generate, based on one or more current models, compressed CSI, the one or more current models being one or more AI/ML based models and determined based on one or more current datasets; receive, from a first node, one or more additional models; generate updated compressed CSI using the received one or more additional models; and transmit, to the first node, the updated compressed CSI.

According to some embodiments of the present disclosure, there is provided a second node for a communication. The second node includes a memory storing an instruction; and a processor configured to execute the instruction stored in the memory to: generate compressed CSI based on one or more current models, the one or more current models being one or more AI/ML based models and determined based on one or more current datasets; transmit, to a first node, the generated compressed CSI; determine whether the one or more current models are feasible for at least one of: CSI generation or CSI reconstruction; train, in response to a determination that the one or more current models are not feasible for at least one of the CSI generation or the CSI reconstruction, one or more additional models for the CSI reconstruction; and transmit, to the first node, the trained one or more additional models.

According to some embodiments of the present disclosure, there is provided a second node for a communication. The second node includes a memory storing an instruction; and a processor configured to execute the instruction stored in the memory to: transmit, to a first node, compressed CSI generated based on one or more current models, the one or more current models being one or more AI/ML based models and determined based on one or more current datasets; determine whether the one or more current models are feasible for at least one of: CSI generation or CSI reconstruction; transmit, to the first node, a request for one or more additional models, in response to a determination that the one or more current models are not feasible for at least one of the CSI generation or the CSI reconstruction; receive, from the first node, the one or more additional models; and transmit, to the first node, updated compressed CSI generated based on the one or more additional models.

According to some embodiments of the present disclosure, there is provided a first node for a communication. The first node includes a memory storing an instruction; and a processor configured to execute the instruction stored in the memory to: receive, from a second node, compressed CSI generated based on one or more current models, the one or more current models being one or more AI/ML based models and determined based on one or more current datasets; receive, from the second node, a request for one or more additional datasets or a request for one or more additional models; transmit, to the second node, the one or more additional datasets or the one or more additional models; and receive, from the second node, updated compressed CSI.

According to some embodiments of the present disclosure, there is provided a first node for a communication. The first node includes a memory storing an instruction; and a processor configured to execute the instruction stored in the memory to: receive, from a second node, compressed CSI generated based on one or more current models, the one or more current models being one or more AI/ML based models and determined based on one or more current datasets; determine whether the one or more current models are feasible for at least one of: CSI generation or CSI reconstruction; transmit, to the second node, a request for one or more additional models, in response to a determination that the one or more current models are not feasible for at least one of the CSI generation or the CSI reconstruction; and receive, from the second node, the one or more additional models.

According to some embodiments of the present disclosure, there is provided a second node for a communication. The second node includes a memory storing an instruction; and a processor configured to execute the instruction stored in the memory to: transmit, to a first node, compressed CSI generated based on one or more current models, the one or more current models being one or more AI/ML based models and determined based on one or more current datasets; receive, from the first node, a request for one or more additional models; train, based on one or more additional datasets, the one or more additional models; and transmit, to the first node, the trained one or more additional models.

According to some embodiments of the present disclosure, there is provided a method for a first node for a communication. The method includes receiving, from a second node, compressed CSI generated based on one or more current models, the one or more current models being one or more AI/ML based models and determined based on one or more current datasets; determining whether the one or more current models are feasible for at least one of: CSI generation or CSI reconstruction; obtaining, in response to a determination that the one or more current models are not feasible for at least one of the CSI generation or the CSI reconstruction, one or more additional models for generation of updated compressed CSI; and transmitting, to the second node, the one or more additional models.

According to some embodiments of the present disclosure, there is provided a method for a second node for a communication. The method includes generating, based on one or more current models, compressed CSI, the one or more current models being one or more AI/ML based models and determined based on one or more current datasets; receiving, from a first node, one or more additional models; generating updated compressed CSI using the received one or more additional models; and transmitting, to the first node, the updated compressed CSI.

According to some embodiments of the present disclosure, there is provided a method for a second node for a communication. The method includes generating compressed CSI based on one or more current models, the one or more current models being one or more AI/ML based models and determined based on one or more current datasets; transmitting, to a first node, the generated compressed CSI; determining whether the one or more current models are feasible for at least one of: CSI generation or CSI reconstruction; training, in response to a determination that the one or more current models are not feasible for at least one of the CSI generation or the CSI reconstruction, one or more additional models for the CSI reconstruction; and transmitting, to the first node, the trained one or more additional models.

According to some embodiments of the present disclosure, there is provided a method for a second node for a communication. The method includes transmitting, to a first node, compressed CSI generated based on one or more current models, the one or more current models being one or more AI/ML based models and determined based on one or more current datasets; determining whether the one or more current models are feasible for at least one of: CSI generation or CSI reconstruction; transmitting, to the first node, a request for one or more additional models, in response to a determination that the one or more current models are not feasible for at least one of the CSI generation or the CSI reconstruction; receiving, from the first node, the one or more additional models; and transmitting, to the first node, updated compressed CSI generated based on the one or more additional models.

According to some embodiments of the present disclosure, there is provided a method for a first node for a communication. The method includes receiving, from a second node, compressed CSI generated based on one or more current models, the one or more current models being one or more AI/ML based models and determined based on one or more current datasets; receiving, from the second node, a request for one or more additional datasets or a request for one or more additional models; transmitting, to the second node, the one or more additional datasets or the one or more additional models; and receiving, from the second node, updated compressed CSI.

According to some embodiments of the present disclosure, there is provided a method for a first node for a communication. The method includes receiving, from a second node, compressed CSI generated based on one or more current models, the one or more current models being one or more AI/ML based models and determined based on one or more current datasets; determining whether the one or more current models are feasible for at least one of: CSI generation or CSI reconstruction; transmitting, to the second node, a request for one or more additional models, in response to a determination that the one or more current models are not feasible for at least one of the CSI generation or the CSI reconstruction; and receiving, from the first node, the one or more additional models.

According to some embodiments of the present disclosure, there is provided a method for a second node for a communication. The method includes transmitting, to a first node, compressed CSI generated based on one or more current models, the one or more current models being one or more AI/ML based models and determined based on one or more current datasets; receiving, from the first node, a request for one or more additional models; training, based on one or more additional datasets, the one or more additional models; and transmitting, to the first node, the trained one or more additional models.

According to some embodiments of the present disclosure, there is provided a non-transitory computer-readable medium storing instructions that are executable by one or more processors of a first node for communication to perform a method. The method includes receiving, from a second node, compressed CSI generated based on one or more current models, the one or more current models being one or more AI/ML based models and determined based on one or more current datasets; determining whether the one or more current models are feasible for at least one of: CSI generation or CSI reconstruction; obtaining, in response to a determination that the one or more current models are not feasible for at least one of the CSI generation or the CSI reconstruction, one or more additional models for generation of updated compressed CSI; and transmitting, to the second node, the one or more additional models.

According to some embodiments of the present disclosure, there is provided a non-transitory computer-readable medium storing instructions that are executable by one or more processors of a second node for a communication to perform a method. The method includes generating, based on one or more current models, compressed CSI, the one or more current models being one or more AI/ML based models and determined based on one or more current datasets; receiving, from a first node, one or more additional models; generating updated compressed CSI using the received one or more additional models; and transmitting, to the first node, the updated compressed CSI.

According to some embodiments of the present disclosure, there is provided a non-transitory computer-readable medium storing instructions that are executable by one or more processors of a second node for a communication to perform a method. The method includes generating compressed CSI based on one or more current models, the one or more current models being one or more AI/ML based models and determined based on one or more current datasets; transmitting, to a first node, the generated compressed CSI; determining whether the one or more current models are feasible for at least one of: CSI generation or CSI reconstruction; training, in response to a determination that the one or more current models are not feasible for at least one of the CSI generation or the CSI reconstruction, one or more additional models for the CSI reconstruction; and transmitting, to the first node, the trained one or more additional models.

According to some embodiments of the present disclosure, there is provided a non-transitory computer-readable medium storing instructions that are executable by one or more processors of a second node for a communication to perform a method. The method includes transmitting, to a first node, compressed CSI generated based on one or more current models, the one or more current models being one or more AI/ML based models and determined based on one or more current datasets; determining whether the one or more current models are feasible for at least one of: CSI generation or CSI reconstruction; transmitting, to the first node, a request for one or more additional models, in response to a determination that the one or more current models are not feasible for at least one of the CSI generation or the CSI reconstruction; receiving, from the first node, the one or more additional models; and transmitting, to the first node, updated compressed CSI generated based on the one or more additional models.

According to some embodiments of the present disclosure, there is provided a non-transitory computer-readable medium storing instructions that are executable by one or more processors of a first node for a communication to perform a method. The method includes receiving, from a second node, compressed CSI generated based on one or more current models, the one or more current models being one or more AI/ML based models and determined based on one or more current datasets; receiving, from the second node, a request for one or more additional datasets or a request for one or more additional models; transmitting, to the second node, the one or more additional datasets or the one or more additional models; and receiving, from the second node, updated compressed CSI.

According to some embodiments of the present disclosure, there is provided a non-transitory computer-readable medium storing instructions that are executable by one or more processors of a first node for a communication to perform a method. The method includes receiving, from a second node, compressed CSI generated based on one or more current models, the one or more current models being one or more AI/ML based models and determined based on one or more current datasets; determining whether the one or more current models are feasible for at least one of: CSI generation or CSI reconstruction; transmitting, to the second node, a request for one or more additional models, in response to a determination that the one or more current models are not feasible for at least one of the CSI generation or the CSI reconstruction; and receiving, from the first node, the one or more additional models.

According to some embodiments of the present disclosure, there is provided a non-transitory computer-readable medium storing instructions that are executable by one or more processors of a second node for a communication to perform a method. The method includes transmitting, to a first node, compressed CSI generated based on one or more current models, the one or more current models being one or more AI/ML based models and determined based on one or more current datasets; receiving, from the first node, a request for one or more additional models; training, based on one or more additional datasets, the one or more additional models; and transmitting, to the first node, the trained one or more additional models.

### BRIEF DESCRIPTION OF DRAWINGS

FIG. 1A is a schematic diagram illustrating CSI feedback for downlink transmissions; and FIG. 1B is a schematic diagram illustrating that CSI feedback for uplink transmissions is not needed, consistent with some embodiments of the present disclosure.

FIG. 2 is a schematic diagram illustrating an autoencoder including an encoder and a decoder, consistent with some embodiments of the present disclosure.

FIG. 3 is a schematic diagram illustrating an exemplary structure of an autoencoder, consistent with some embodiments of the present disclosure.

FIG. 4 is a schematic diagram illustrating an architecture of applying an autoencoder to CSI compression, consistent with some embodiments of the present disclosure.

FIG. 5 is a schematic diagram illustrating a process of applying an autoencoder to CSI compression, consistent with some embodiments of the present disclosure.

FIG. 6 is a schematic diagram illustrating a procedure for model training in a communication system, consistent with some embodiments of the present disclosure.

FIG. 7 is a schematic diagram illustrating a procedure for model training in a communication system, consistent with some embodiments of the present disclosure.

FIG. 8 is a schematic diagram illustrating a procedure for model training in a communication system, consistent with some embodiments of the present disclosure.

FIG. 9 is a schematic diagram illustrating a procedure for model training in a communication system, consistent with some embodiments of the present disclosure.

FIG. 10 is a schematic diagram illustrating a procedure for model training in a communication system, consistent with some embodiments of the present disclosure.

FIG. 11 is a schematic diagram illustrating a procedure for model training in a communication system, consistent with some embodiments of the present disclosure.

FIG. 12 is a schematic diagram illustrating a procedure for model training in a communication system, consistent with some embodiments of the present disclosure.

FIG. 13 is a schematic diagram illustrating a procedure for model training in a communication system, consistent with some embodiments of the present disclosure.

FIG. 14 is a schematic diagram illustrating a procedure for model training in a communication system, consistent with some embodiments of the present disclosure.

FIG. 15 is a schematic diagram illustrating a method for a first node for a communication, consistent with some embodiments of the present disclosure.

FIG. 16 is a schematic diagram illustrating a method for a second node for a communication, consistent with some embodiments of the present disclosure.

FIG. 17 is a schematic diagram illustrating a method for a second node for a communication, consistent with some embodiments of the present disclosure.

FIG. 18 is a schematic diagram illustrating a method for a second node for a communication, consistent with some embodiments of the present disclosure.

FIG. 19 is a schematic diagram illustrating a method for a first node for a communication, consistent with some embodiments of the present disclosure.

FIG. 20 is a schematic diagram illustrating a method for a first node for a communication, consistent with some embodiments of the present disclosure.

FIG. 21 is a schematic diagram illustrating a method for a second node for a communication, consistent with some embodiments of the present disclosure.

FIG. 22 is a block diagram of a device, consistent with some embodiments of the present disclosure.

### DESCRIPTION OF EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

Generally, radio resource allocations/configurations and transmission schemes on an interface between a UE and a base station (e.g., Uu interface) are determined by the base station. To optimize performance of the UE and the base station, the base station should dynamically adjust the radio resource allocations/configurations and the transmission schemes based on the current channel condition on the Uu interface. To this end, the base station should be aware of the current channel condition on the Uu interface, both in the downlink (DL) and uplink (UL) transmissions.

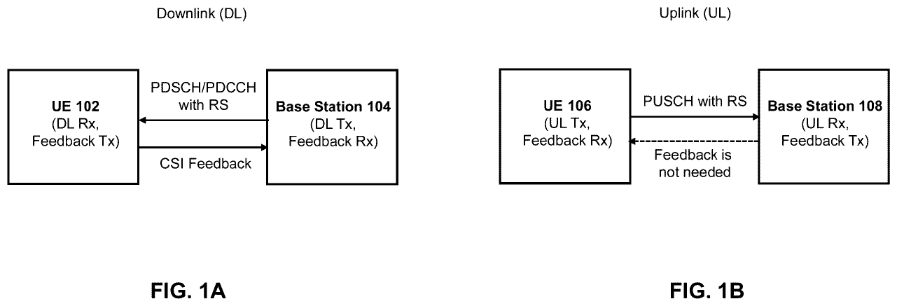

FIG. 1A is a schematic diagram illustrating CSI feedback for DL transmissions; and FIG. 1B is a schematic diagram illustrating that CSI feedback for UL transmissions is not needed, consistent with some embodiments of the present disclosure. As shown in FIG. 1A, a communication system includes a UE 102 and a base station 104. The UE 102 can be any UE, for example, a mobile device, such as a vehicle or a device mounted in a vehicle, or a device carried by, held by, or otherwise associated with a person. The base station 104 can be any base station currently existing, such as base stations for long term evolution (LTE) or new radio (NR), or base stations for a future generation (6^{th} generation (6G) or any other future generation) radio access technology. Referring to FIG. 1A, in a DL transmission, the base station 104 is a transmitter and the UE 102 is a receiver of the DL traffic. To estimate channel condition in the DL transmission, the base station 104 may transmit one or more reference signals (RS) on physical downlink shared channel (PDSCH) and/or physical downlink control channel (PDCCH). The sequences and/or formats of the reference signals may be consistent with the 3^{rd} Generation Partnership Project (3GPP) standards. Upon receiving the reference signals, the UE 102 may estimate the DL channel condition based on measurements on the received reference signals. For example, the UE 102 may perform the measurements on the reference signals and the determine a channel quality and a degree of distortion of the reference signals. The UE 102 may further inform the base station 104 about the knowledge of the DL channel condition by transmitting CSI feedback to the base station. In this case, the UE 102 is a transmitter of the CSI and the base station 104 is a receiver of the CSI. The content of the CSI may include, but is not limited to, channel quality indicator (CQI), precoding matrix indicator (PMI), CSI-RS resource indicator (CRI), synchronization signal and physical broadcast channel resource block indicator (SSBRI), layer indicator (LI) and rank indicator (RI).

Referring to FIG. 1B, a communication system includes a UE 106 and a base station 108. The UE 106 and the base station 108 may be similar to the UE 102 and the base station 104 of FIG. 1A, respectively. For the sake of brevity, the descriptions of the UE 106 and the base station 108 are omitted here. Referring to FIG. 1B, in a UL transmission, the UE 106 is a transmitter and the base station 108 is a receiver of the UL traffic. To estimate channel condition in the UL transmission, the UE 106 may transmit one or more reference signals, for example, on physical uplink shared channel (PUSCH). Upon receiving the reference signals, the base station 108 may perform measurements on the reference signals and estimate the UL channel condition. For example, the base station 108 may perform measurements on the reference signals to determine distortion of the reference signals. In this case, the base station 108 may (i.e., possibly, but not necessarily) send CSI feedback to the UE 106.

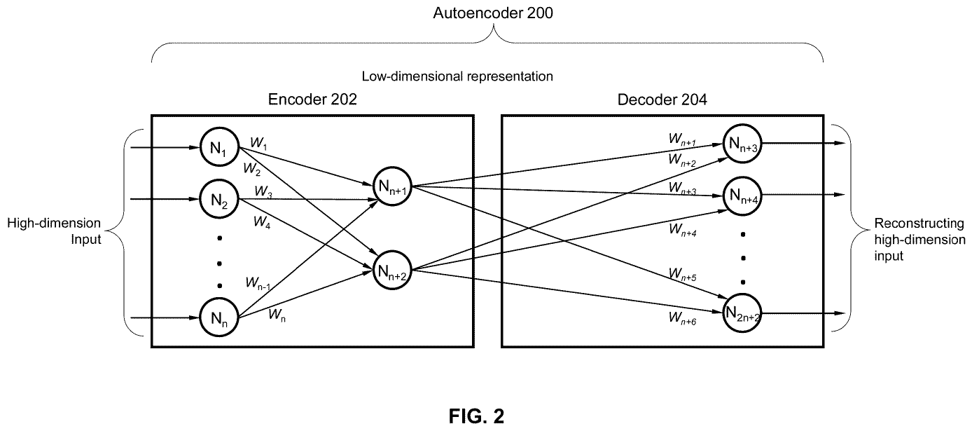

Generally, the dimension of a channel condition may be very high and thus, it is practically a challenge to precisely describe the channel condition. For example, in FIG. 1A, in order to precisely describe the DL channel condition, the UE 102 may need to use a large number of bits in reporting the CSI feedback to the base station 104. At least some embodiments of the present disclosure address this challenge by providing CSI compression that allows to use a fewer number of bits to report the CSI. For example, at least some embodiments of the present disclosure use an encoder of an autoencoder to compress the CSI and use a decoder of the autoencoder to reconstruct the CSI, as discussed with respect to FIGS. 2-5 below. However, use of an autoencoder is merely an exemplary technique and the embodiments of the present disclosure are not so limited. Any data compression/reconstruction and/or AI/ML based techniques or algorithms currently known in the art or developed in the future can be implemented in the embodiments of the present disclosure. AI/ML described in this disclosure may be AI and/or ML.

FIG. 2 is a schematic diagram illustrating an autoencoder including an encoder and a decoder, consistent with some embodiments of the present disclosure. Referring to FIG. 2, an autoencoder 200 includes an encoder 202 and a decoder 204. In some embodiments, the autoencoder 200 may implement unsupervised learning methods based on deep neural networks, for example, the neural network including a plurality of neural nodes as illustrated in FIG. 2. Referring to FIG. 2, the encoder 202 includes a plurality of neural nodes (neural nodes N₁ to Nₙ₊₂). Similarly, the decoder 204 includes a plurality of neural nodes (neural nodes Nₙ₊₃ to N₂ₙ₊₂). The neural nodes that belong to the same operation stage form a layer. For example, the neural nodes Ni to Nn form a layer, and the neural nodes Nₙ₊₁ and Nₙ₊₂ form another layer. There are a number of links connecting the neural nodes in different layers, and each link is multiplied by a weight/parameter (W). FIG. 2 shows the weights/parameters (W₁ to Wₙ₊₆) associated with each link. For example, the link connecting the neural node N₁ and the neural node Nₙ₊₁ is multiplied by a weight/parameter W₁, and the link connecting the neural node Nₙ₊₁ and the neural node N₂ₙ₊₂ is multiplied by a weight/parameter Wₙ₊₅. In some embodiments, at each neural node, a non-linear operation (e.g., sigmoid function, step function, etc.) is applied to all the inputs (multiplied by the corresponding weights and/or parameters) to generate the output. Before the output of a neural node becomes the input of the neural node in the next layer, the output may be multiplied by the corresponding weight and/or parameter. Generally, the input of the encoder 202 may be of a very high dimension. The encoder 202 may reduce the dimension and output a low-dimensional representation of the input. The output of the encoder 202 becomes the input of the decoder 204. The decoder 204 may reconstruct the low-dimensional input as a high-dimensional output.

Still referring to FIG. 2, in some embodiments, the output of the decoder 204 and the input of the encoder 202 are identical. In some embodiments, to make the input of the encoder 202 and the output of the decoder 204 identical, all the weights and/or parameters in both the encoder 202 and decoder 204 are adequately adjusted/updated for any arbitrary input of the autoencoder 200. In some embodiments, a structure of the encoder 202 may be specified based on at least one of the following characteristics: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes. Similarly, a structure of the decoder 204 may be specified based on at least one of the following characteristics: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes.

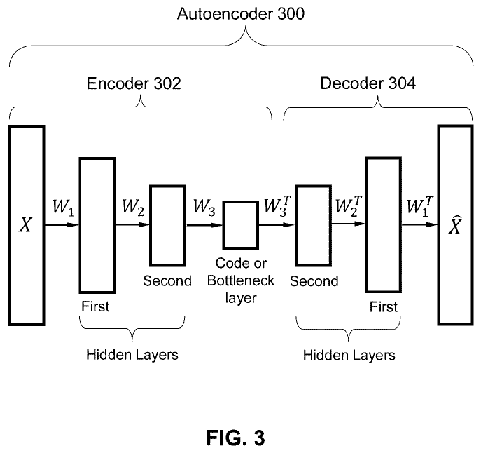

FIG. 3 is a schematic diagram illustrating an exemplary structure of an autoencoder, consistent with some embodiments of the present disclosure. Referring to FIG. 3, an autoencoder 300 has a sandwich structure in which an encoder 302 and a decoder 304 are symmetric. The symmetry may be characterized in the following aspects: (1) the numbers of layers in the encoder 302 and in the decoder 304 are the same, except that there is one additional layer known as a code or a bottleneck layer in the encoder 302; (2) the number of neural nodes in the input layer (X) of the encoder 302 is the same as the number of neural nodes in the output layer (\hat{X}) of the decoder 304; (3) the number of hidden layers in the encoder 302 and the number of hidden layers in the decoder 304 are the same; or (4) the vector of weights/parameters (W₁) between the input layer and the first hidden layer in the encoder 302 is the transpose of the vector of weights/parameters (W^{T}₁) between the output layer and the first hidden layer in the decoder 304, and the vector of weights/parameters (W₂) between the first hidden layer and the second hidden layer in the encoder 302 is the transpose of the vector of weights/parameters (W^{T}₂) between the first hidden layer and the second hidden layer in the decoder 304, and so on. In the present disclosure, a hidden layer indicates a layer that is not the input layer, output layer, or a code/bottleneck layer. The bottleneck layer may be designed to restrict the flow of information to the decoder 304 from the encoder 302, allowing only the most vital information to pass through.

In some embodiments, for the sandwich structure, the encoder 302 and the decoder 304 of the autoencoder 300 may synchronize their structures and weights/parameters. In some embodiments, the structure of the autoencoder is designed to be sophisticated, in order to significantly reduce the dimension of the encoder input and fully reconstruct the compressed representation at the output of the decoder. In some embodiments, the structure of the autoencoder is designed to be simple, in order to simplify the process and minimize errors between the input and output of the autoencoder.

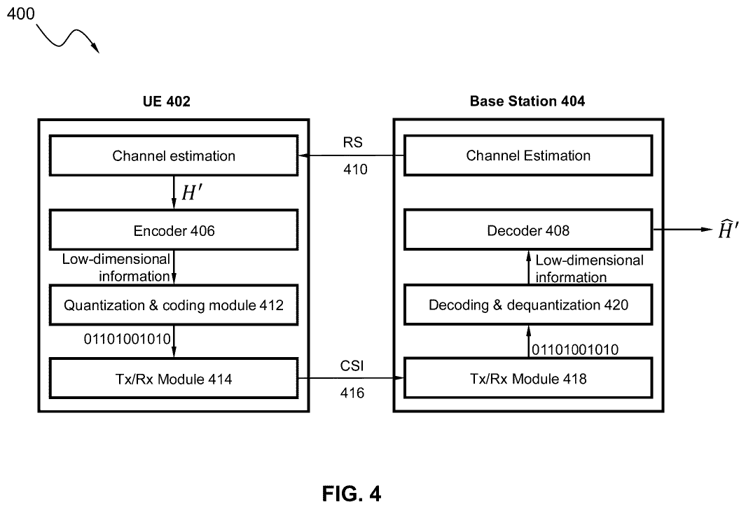

FIG. 4 is a schematic diagram illustrating an architecture of applying an autoencoder to CSI compression, consistent with some embodiments of the present disclosure. Referring to FIG. 4, a communication system 400 includes a UE 402 and a base station 404. The UE 402 includes an encoder 406 of an autoencoder and the base station 404 includes a decoder 408 of the autoencoder. In a process 410, the base station 404 transmits one or more reference signals (RS) to the UE 402. For example, the base station 404 may transmit the one or more reference signals on PDSCH and/or PDCCH. Upon receiving the one or more reference signals, the UE 402 estimates the downlink channel condition (denoted as H′). For example, the UE 402 may estimate the channel condition by performing measurements on the received reference signals. The encoder 406 of the UE 402 then compresses the channel condition information (data) to low dimensional information. The low dimensional information is then fed to a quantization and coding module 412 to transfer the low dimensional information to a bit stream having a certain number of bits. An exemplary bit stream (01101001010) is shown in FIG. 4. At a process 416, a transceiver (Tx/Rx) module 414 of the UE 402 then transmits the bit stream (CSI) to the base station 404.

At the base station 404, a Tx/Rx module 418 receives the bit stream (CSI). The bit stream is fed to a decoding and dequantization module 420 to transfer the bit stream to low dimensional information. The decoder 408 of the base station 404 then reconstructs the high-dimensional channel condition (denoted as Ĥ′) using the low dimensional information and outputs the reconstructed channel condition. In FIG. 4, the encoder 406 and the quantization and coding module 412 of the UE 402 may form the CSI generation part, and the decoder 408 and the decoding and dequantization module 420 of the base station 404 may form the CSI construction part. The term “module” described in the present disclosure can be pure software, pure hardware, or a combination of software and hardware.

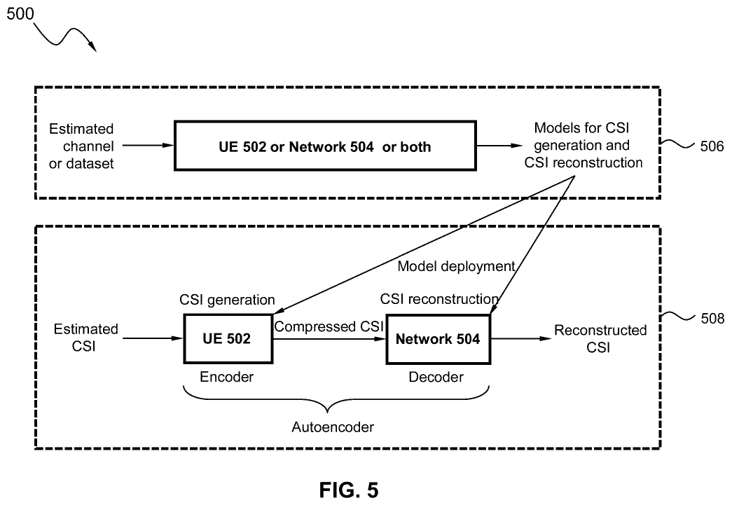

FIG. 5 is a schematic diagram illustrating a process of applying an autoencoder to CSI compression, consistent with some embodiments of the present disclosure. Referring to FIG. 5, a process 500 of applying an autoencoder to CSI compression involves two phases: a model training phase 506 and a machine inference phase 508. The term “training” described in the present disclosure may or may not include a testing process. The model training phase 506 may be performed by a UE 502 or a network 504, or both the UE 502 and the network 504. The UE 502 includes an encoder of an autoencoder and generates compressed CSI. The network 504 includes a decoder of the autoencoder and performs CSI reconstruction. At the model training phase 506, based on the channel estimation and/or dataset, the weights/parameters for the encoder in the CSI generation part and the weights/parameters for the decoder in the CSI reconstruction part are updated, and/or new models are adopted. In some embodiments, the model training may be an off-line training in which labeled examples or labeled datasets are available for the model training. With the labeled examples or labeled datasets, the UE 502 and/or the network 504 may perform the off-line model training. In some embodiments, the model training may be an on-line training in which labeled examples or labeled datasets are not available for the model training. In this case, the UE 502 and/or the network 504 may interact with the environment and train the model through the interaction with the environment. At the machine inference phase 508, after the weights/parameters of the encoder in the CSI generation part and the decoder in the CSI reconstruction part are updated, the updated weights/parameters and/or the new models are deployed to the UE 502 and the network 504. The UE 502 then generates compressed CSI using the new models and the network 504 then reconstructs the CSI using the new models.

For off-line model training, there are at least two challenges. The first challenge is determining which node (UE or network or both) should trigger the model training. At an initial stage, initial models can be deployed to the CSI generation part for CSI compression and the CSI reconstruction part for CSI reconstruction. However, communication environment may change over time and this change may degrade performance of CSI compression. When performance degrades, new models need to be trained and deployed to the CSI generation part and the CSI reconstruction part to replace the old models. To this end, the UE or the network or both should identify infeasibility of the current models and trigger a new model training. In general, when the labelled examples or labelled datasets are available to a node (UE or network), the node is able to identify feasibility/infeasibility of the current models through comparing the (CSI compression or CSI reconstruction) results in machine inference and in model training. If there are significant differences between the results in machine inference and in model training, then the current models may be infeasible. Selecting which node (UE or network or both) to train the new models directly affects the overall performance of the channel condition estimation. The second challenge in generating compressed CSI is determining the procedure to support the model training. Both UE and network may have the capability to perform model training. In addition, the network may include a base station and a core network. To enable these nodes (the UE or the base station or the core network) to perform the model training, different procedures are needed. Selecting which procedure to train the new models also affects the overall performance of the channel condition estimation. At least some embodiments of the present disclosure provide solutions to the above-noted challenges.

In some embodiments, in order to apply an autoencoder to the CSI compression part in a UE side and the CSI reconstruction part in a network side, both the UE and the network agree on the adopted structures for the CSI compression part and CSI reconstruction part. For this purpose, in some embodiments, a preliminary stage is implemented before the model training. In the preliminary stage, for example, a certain number of structures of the encoder and the decoder of an autoencoder for CSI feedback may be provided in standards (e.g., the 3GPP standards). In some embodiments, the network may inform the supported encoder and decoder structures (all or a part of structures in the standards) to the UE. This information can be conveyed, for example, through MasterInformationBlock (MIB) or SystemInformationBlock (SIB). In some embodiments, the UE may inform the supported encoder and decoder structures (all or a part of structures in standards) to the network. This information can be conveyed, for example, through UE capability information of a radio resource control (RRC) signaling. In some embodiments, initially, the adopted encoder and decoder structures may be determined by the network (base station or core network) and the network informs the configuration to the UE. In some embodiments, initially, the adopted encoder and decoder structures may be determined by the UE and the UE informs the configuration to the network. In this case, the network may allocate radio resources for the UE to send the configuration to the network. In some embodiments, initially, the adopted encoder and decoder structures may be specified in standards.

In some embodiments, initially, the adopted weights/parameters of both the encoder and decoder may be determined by the network and the network informs the configuration to the UE. In some embodiments, initially, the adopted weights/parameters of both the encoder and the decoder may be determined by the UE and the UE informs the configuration to the network. In this case, the network may allocate radio resources for the UE to send the configuration to the network. In some embodiments, initially, the adopted weights/parameters of both the encoder and decoder may be specified in standards.

In some embodiments, a certain number of CSI bit stream generation/decoding schemes may be provided in standards. In some embodiments, the network may inform the supported CSI bit stream generation/decoding schemes (all or a part of schemes in the standards) to the UE. This information can be conveyed, for example, through MIB or SIB. In some embodiments, the UE may inform the supported CSI bit stream generation/decoding schemes (all or a part of schemes in the standards) to the network. This information can be conveyed, for example, through UE capability information of an RRC signaling. In some embodiments, initially, the adopted CSI bit stream generation/decoding scheme may be determined by the network and the network informs the configuration to the UE. In some embodiments, initially, the adopted CSI bit stream generation/decoding scheme may be determined by the UE and the UE informs the configuration to the network. In this case, the network allocates radio resources for the UE to send this configuration. In some embodiments, initially, the adopted CSI bit stream generation/decoding scheme may be specified in standards.

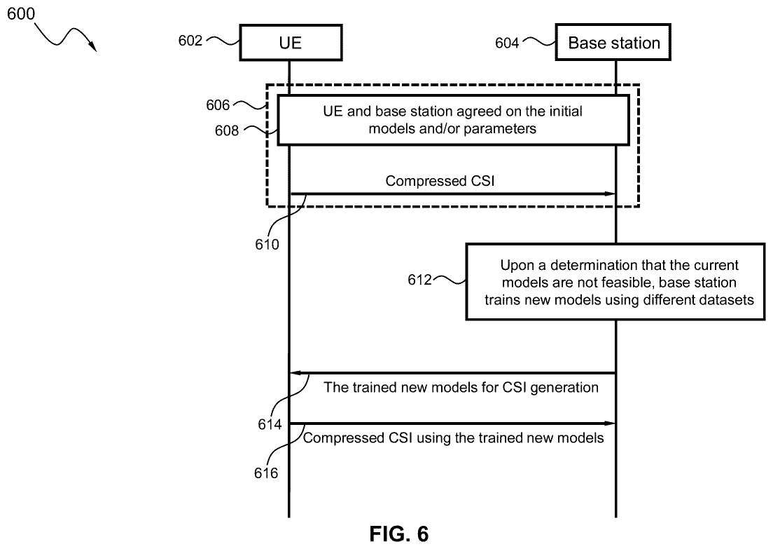

FIG. 6 is a schematic diagram illustrating a procedure for model training in a communication system, consistent with some embodiments of the present disclosure. Referring to FIG. 6, a communication system 600 includes a UE 602 and a base station 604 that perform a procedure for model training. The UE 602 may be similar to the UE 102, the UE 106, the UE 402, or the UE 502 as described with respect to FIGS. 1A, 1B, 4, and 5, and the base station 604 may be similar to the base station 104, the base station 108, the base station 404, or the network 504 as described with respect to FIGS. 1A, 1B, 4, and 5. The procedure for model training may include a machine inference phase 606. In some embodiments, the machine inference phase 606 includes a step 608 in which the UE 602 and the base station 604 agree on the initial models and/or parameters. The machine inference phase 606 also includes a step 610 in which the UE 602 transmits compressed CSI to the base station 604. After the machine inference phase 606, at a step 612, the base station 604 may determine that the current models are not feasible for CSI generation and/or CSI reconstruction. Based on the determination, the base station 604 may train new models using datasets that are partially or fully different from the datasets used for training the current models. After the training, at a step 614, the base station 604 sends the trained new models to the UE 602 for CSI generation. The UE 602 receives the new models and generates updated compressed CSI using the new models. At a step 616, the UE 602 transmits the generated updated compressed CSI to the base station 604. In some embodiments, the models trained by the base station 604 are AI/ML based models.

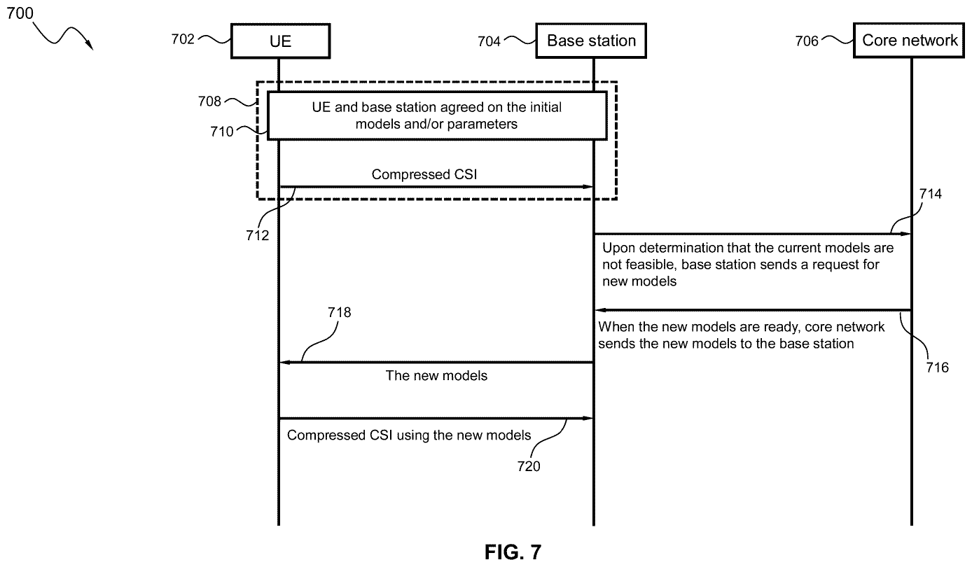

FIG. 7 is a schematic diagram illustrating a procedure for model training in a communication system, consistent with some embodiments of the present disclosure. Referring to FIG. 7, a communication system 700 includes a UE 702, a base station 704, and a core network 706 that perform a procedure for model training. The UE 702 may be similar to the UE 102, the UE 106, the UE 402, or the UE 502 as described with respect to FIGS. 1A, 1B, 4, and 5. The base station 704 may be similar to the base station 104, the base station 108, the base station 404, or the network 504 as described with respect to FIGS. 1A, 1B, 4, and 5. The base station 704 and the core network 706 may form a network. The procedure for model training may include a machine inference phase 708. In some embodiments, the machine inference phase 708 includes a step 710 in which the UE 702 and the base station 704 agree on the initial models and/or parameters. The machine inference phase 708 also includes a step 712 in which the UE 702 transmits compressed CSI to the base station 704. After the machine inference phase 708, at a step 714, the base station 704 may determine that the current models are not feasible for CSI generation and/or CSI reconstruction. Based on the determination, the base station 704 sends a request for new models to the core network 706. Upon receipt of the request, the core network 706 trains the new models and, at a step 716, the core network 706 sends the trained new models to base station 704. At a step 718, the base station 704 forwards the received new models to the UE 702 for CSI generation. The UE 702 receives the new models and generates updated compressed CSI using the new models. At a step 720, the UE 702 transmits the generated updated compressed CSI to the base station 704 for CSI reconstruction. In some embodiments, the models trained by the core network 706 are AI/ML based models.

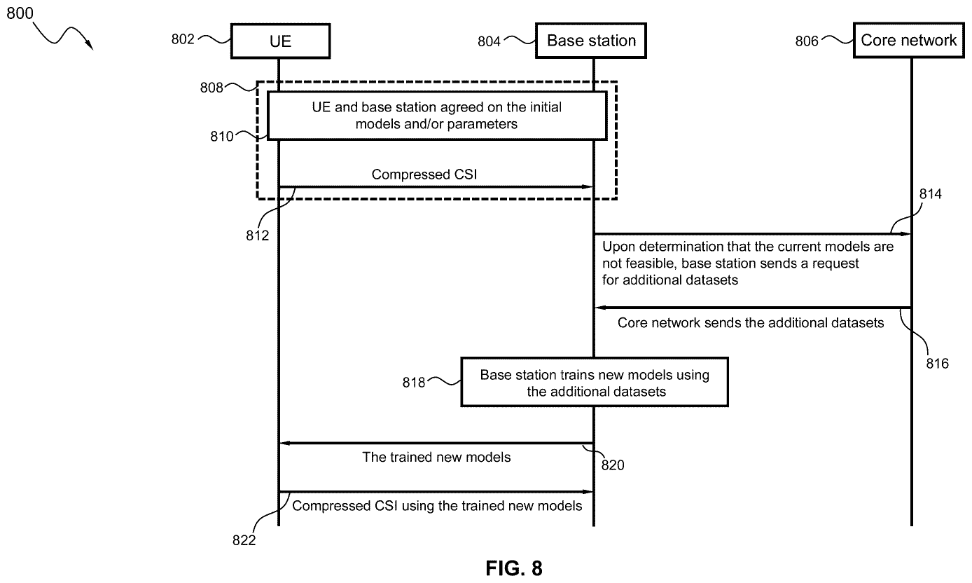

FIG. 8 is a schematic diagram illustrating a procedure for model training in a communication system, consistent with some embodiments of the present disclosure. Referring to FIG. 8, a communication system 800 includes a UE 802, a base station 804, and a core network 806 that perform a procedure for model training. The UE 802 may be similar to the UE 102, the UE 106, the UE 402, or the UE 502 as described with respect to FIGS. 1A, 1B, 4, and 5. The base station 804 may be similar to the base station 104, the base station 108, the base station 404, or the network 504 as described with respect to FIGS. 1A, 1B, 4, and 5. The base station 804 and the core network 806 may form a network. The procedure for model training may include a machine inference phase 808. In some embodiments, the machine inference phase 808 includes a step 810 in which the UE 802 and the base station 804 agree on the initial models and/or parameters. The machine inference phase 808 also includes a step 812 in which the UE 802 transmits compressed CSI to the base station 804. After the machine inference phase 808, at a step 814, the base station 804 may determine that the current models are not feasible for CSI generation and/or CSI reconstruction. Based on the determination, the base station 804 sends a request for additional datasets to the core network 806. Upon receipt the request, at a step 816, the core network 806 sends the requested additional datasets to the base station 804. The additional datasets may be datasets that are partially or fully different from the datasets used for training the current models. At a step 818, the base station 804 may train new models using the additional datasets. At a step 820, the base station 804 may send the trained new models to the UE 802 for CSI generation.

The UE 802 receives the new models and generates updated compressed CSI using the new models. At a step 822, the UE 802 transmits the generated updated compressed CSI to the base station 804 for CSI reconstruction. In some embodiments, the models trained by the base station 804 are AI/ML based models.

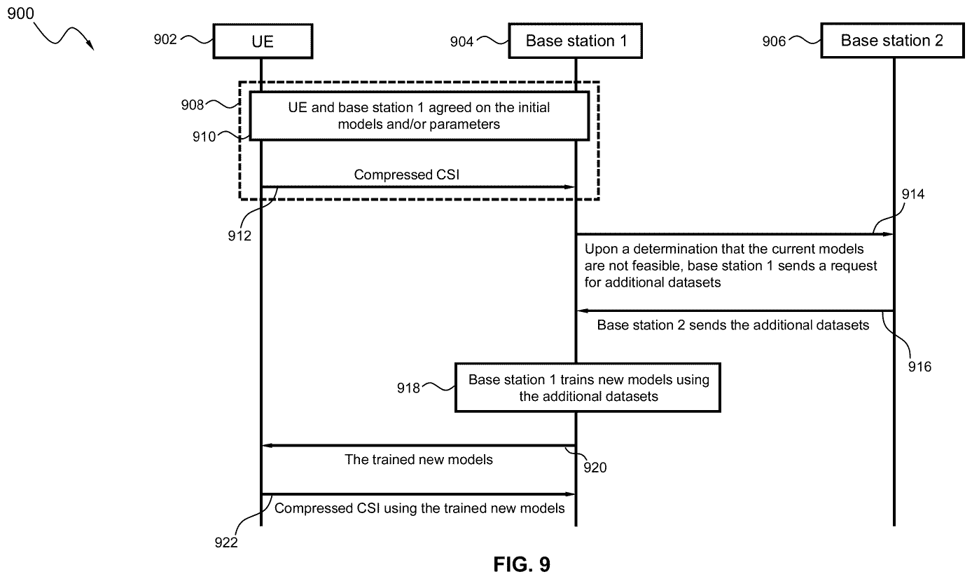

FIG. 9 is a schematic diagram illustrating a procedure for model training in a communication system, consistent with some embodiments of the present disclosure. Referring to FIG. 9, a communication system 900 includes a UE 902, a base station 904 (base station 1), and a base station 906 (base station 2) that perform a procedure for model training. The UE 902 may be similar to the UE 102, the UE 106, the UE 402, or the UE 502 as described with respect to FIGS. 1A, 1B, 4, and 5. The base station 904 and/or the base station 906 may be similar to the base station 104, the base station 108, the base station 404, or the network 504 as described with respect to FIGS. 1A, 1B, 4, and 5. In FIG. 9, the base station 904 is a serving base station for the UE 902 and serves as a central connection point for the UE 902 for communication, while the base station 906 is a non-serving base station for the UE 902. As shown in FIG. 9, the model training procedure may include a machine inference phase 908. In some embodiments, the machine inference phase 908 includes a step 910 in which the UE 902 and the base station 904 agree on the initial models and/or parameters. The machine inference phase 908 also includes a step 912 in which the UE 902 transmits compressed CSI to the base station 904. After the machine inference phase 908, at a step 914, the base station 904 determines that the current models are not feasible for CSI generation and/or CSI construction. Based on the determination, the base station 904 sends a request for additional datasets to the base station 906. Upon reception the request, at a step 916, the base station 906 sends the additional datasets to the base station 904. The additional datasets may be datasets that are partially or fully different from the datasets used for training the current models. At a step 918, the base station 904 trains new models using the additional datasets. At a step 920, the base station 904 sends the trained new models to the UE 902 for CSI generation. The UE 902 receives the new models and generates updated compressed CSI using the new models. At a step 922, the UE 902 transmits the generated updated compressed CSI to the base station 904 for CSI reconstruction. In some embodiments, the models trained by the base station 904 are AI/ML based models.

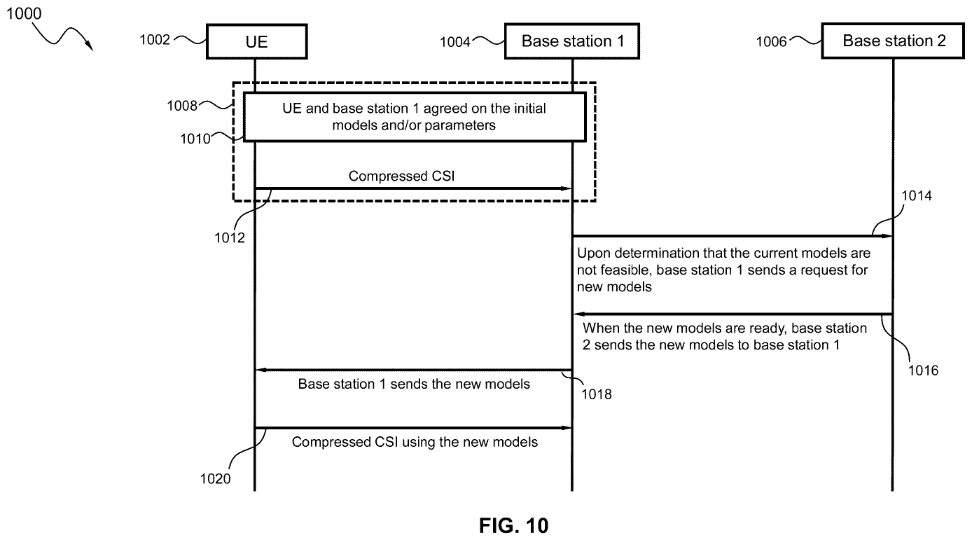

FIG. 10 is a schematic diagram illustrating a procedure for model training in a communication system, consistent with some embodiments of the present disclosure. Referring to FIG. 10, a communication system 1000 includes a UE 1002, a base station 1004 (base station 1), and a base station 1006 (base station 2) that perform a procedure for model training. The UE 1002 may be similar to the UE 102, the UE 106, the UE 402, or the UE 502 as described with respect to FIGS. 1A, 1B, 4, and 5. The base station 1004 and/or the base station 1006 may be similar to the base station 104, the base station 108, the base station 404, or the network 504 as described with respect to FIGS. 1A, 1B, 4, and 5. In FIG. 10, the base station 1004 is a serving base station for the UE 1002 and serves as a central connection point for the UE 1002 for communication, while the base station 1006 is a non-serving base station for the UE 1002. As shown in FIG. 10, the model training procedure may include a machine inference phase 1008. In some embodiments, the machine inference phase 1008 includes a step 1010 in which the UE 1002 and the base station 1004 agree on the initial models and/or parameters. The machine inference phase 1008 also includes a step 1012 in which the UE 1002 transmits compressed CSI to the base station 1004. After the machine inference phase 1008, at a step 1014, the base station 1004 may determine that the current models are not feasible for CSI generation and/or CSI construction. Based on the determination, the base station 1004 sends a request for new models to the base station 1006. Upon receipt the request, the base station 1006 trains the new models, using additional datasets available for the base station 1006. The additional datasets may be datasets that are partially or fully different from the datasets used for training the current models. At a step 1016, the base station 1006 sends the trained new models to the base station 1004. At a step 1018, the base station 1004 forwards the new models to the UE 1002 for CSI generation. The UE 1002 receives the new models and generates updated compressed CSI using the new models. At a step 1020, the UE 1002 transmits the generated updated compressed CSI to the base station 1004 for CSI reconstruction. In some embodiments, the models trained by the base station 1006 are AI/ML based models.

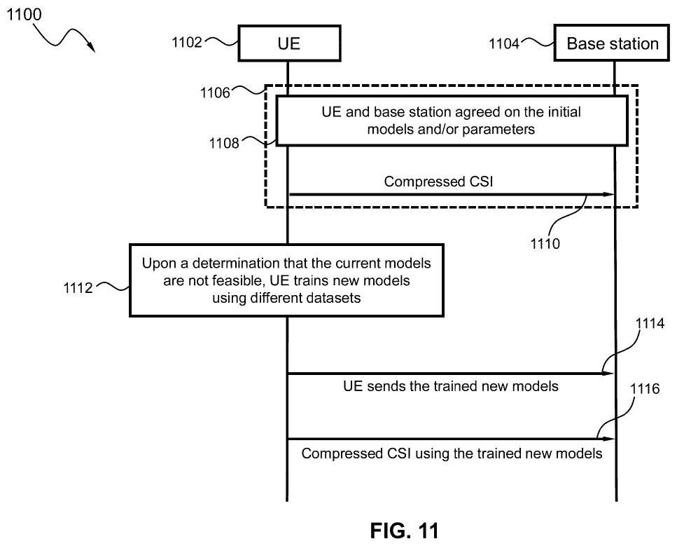

FIG. 11 is a schematic diagram illustrating a procedure for model training in a communication system, consistent with some embodiments of the present disclosure. Referring to FIG. 11, a communication system 1100 includes a UE 1102 and a base station 1104 that perform a procedure for model training. The UE 1102 may be similar to the UE 102, the UE 106, the UE 402, or the UE 502 as described with respect to FIGS. 1A, 1B, 4, and 5, and the base station 1104 may be similar to the base station 104, the base station 108, the base station 404, or the network 504 as described with respect to FIGS. 1A, 1B, 4, and 5. The procedure for model training may include a machine inference phase 1106. In some embodiments, the machine inference phase 1106 includes a step 1108 in which the UE 1102 and the base station 1104 agree on the initial models and/or parameters. The machine inference phase 1106 also includes a step 1110 in which the UE 1102 transmits compressed CSI to the base station 1104. After the machine inference phase 1106, at a step 1112, the UE 1102 may determine that the current models are not feasible for CSI generation and/or CSI reconstruction. Based on the determination, the UE 1102 trains new models using datasets that are partially or fully different from the datasets used for training the current models. At a step 1114, the UE 1102 then sends the trained new models to the base station 1104 for CSI reconstruction. The UE 1102 also generates updated compressed CSI using the trained new models. At a step 1116, the UE 1102 transmits the generated updated compressed CSI to the base station 1104 for CSI reconstruction. In some embodiments, the models trained by the UE 1102 are AI/ML based models.

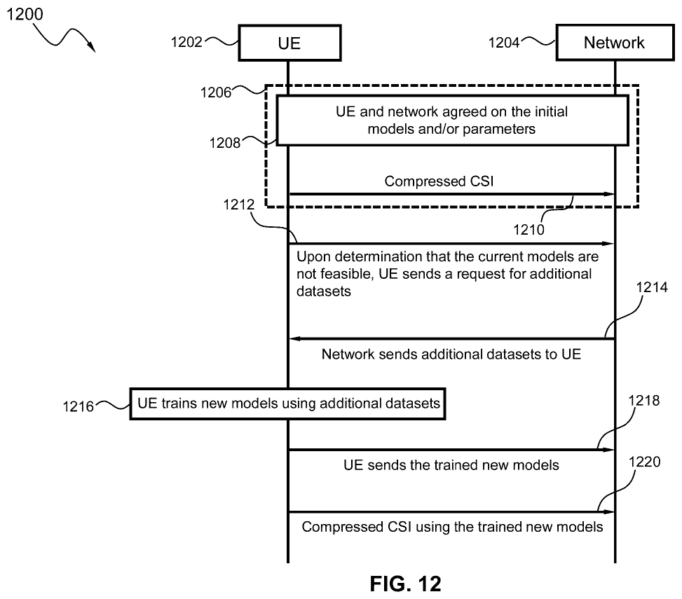

FIG. 12 is a schematic diagram illustrating a procedure for model training in a communication system, consistent with some embodiments of the present disclosure. Referring to FIG. 12, a communication system 1200 includes a UE 1202 and a network 1204 that perform a procedure for model training. The UE 1202 may be similar to the UE 102, the UE 106, the UE 402, or the UE 502 as described with respect to FIGS. 1A, 1B, 4, and 5. The network 1204 may be a base station or a core network or both. For example, the network 1204 may be similar to the base station 104, the base station 108, the base station 404, or the network 504 as described with respect to FIGS. 1A, 1B, 4, and 5. The procedure for model training may include a machine inference phase 1206. In some embodiments, the machine inference phase 1206 includes a step 1208 in which the UE 1202 and the network 1204 agree on the initial models and/or parameters. The machine inference phase 1206 also includes a step 1210 in which the UE 1202 transmits compressed CSI to the network 1204. After the machine inference phase 1206, at a step 1212, the UE 1202 determines that the current models are not feasible for CSI generation and/or CSI reconstruction. Based on the determination, the UE 1202 sends a request for additional datasets to the network 1204. At a step 1214, the network 1204 sends the additional datasets to the UE 1204. The additional datasets may be datasets that are partially or fully different from the datasets used for training the current models. At a step 1216, the UE 1202 trains new models using the additional datasets. At a step 1218, the UE 1202 then sends the trained new models to the network 1204 for CSI reconstructions. The UE 1202 also generates updated compressed CSI using the trained new models. At a step 1220, the UE 1202 transmits the generated updated compressed CSI to the network 1204. In some embodiments, the models trained by the UE 1202 are AI/ML based models.

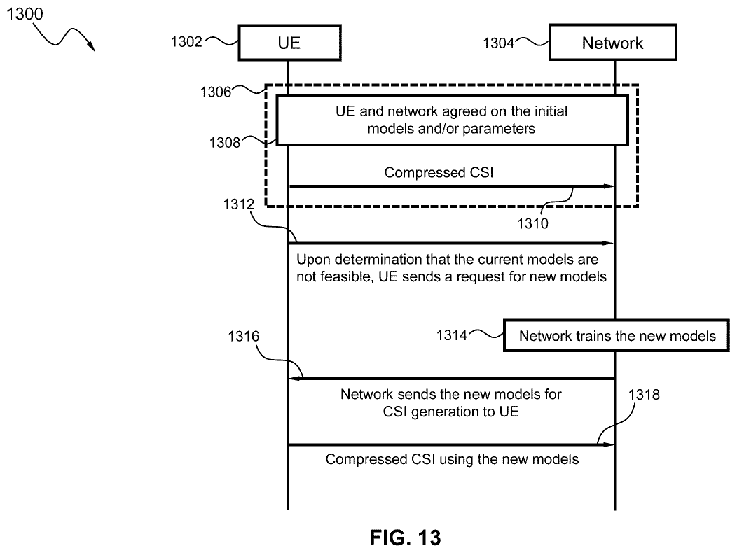

FIG. 13 is a schematic diagram illustrating a procedure for model training in a communication system, consistent with some embodiments of the present disclosure. Referring to FIG. 13, a communication system 1300 includes a UE 1302 and a network 1304 that perform a procedure for model training. The UE 1302 may be similar to the UE 102, the UE 106, the UE 402, or the UE 502 as described with respect to FIGS. 1A, 1B, 4, and 5. The network 1304 may be a base station or a core network or both. For example, the network 1304 may be similar to the base station 104, the base station 108, the base station 404, or the network 504 as described with respect to FIGS. 1A, 1B, 4, and 5. The procedure for model training may include a machine inference phase 1306. In some embodiments, the machine inference phase 1306 includes a step 1308 in which the UE 1302 and the network 1304 agree on the initial models and/or parameters. The machine inference phase 1306 also includes a step 1310 in which the UE 1302 transmits compressed CSI to the network 1304. After the machine inference phase 1306, at a step 1312, the UE 1302 may determine that the current models are not feasible for CSI generation and/or CSI reconstruction. Based on the determination, the UE 1302 sends a request for new models to the network 1304. At a step 1314, the network 1304 trains the new models using datasets that are partially or fully different from the datasets used for training the current models. At a step 1316, the network 1304 sends the trained new models to the UE 1302. The UE 1302 generates updated compressed CSI using the received new models. At a step 1318, the UE 1302 transmits the generated updated compressed CSI to the network 1304 for CSI reconstruction. In some embodiments, the models trained by the network 1304 are AI/ML based models.

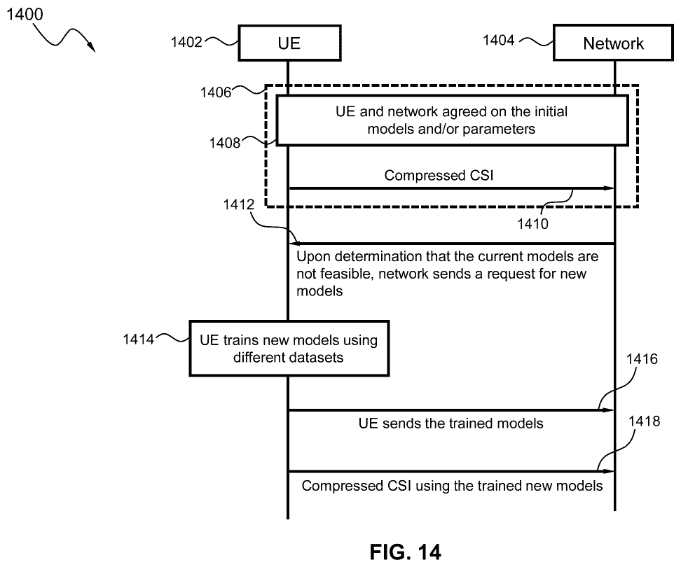

FIG. 14 is a schematic diagram illustrating a procedure for model training in a communication system, consistent with some embodiments of the present disclosure. Referring to FIG. 14, a communication system 1400 includes a UE 1402 and a network 1404 that perform a procedure for model training. The UE 1402 may be similar to the UE 102, the UE 106, the UE 402, or the UE 502 as described with respect to FIGS. 1A, 1B, 4, and 5. The network 1404 may be a base station or a core network or both. For example, the network 1404 may be similar to the base station 104, the base station 108, the base station 404, or the network 504 as described with respect to FIGS. 1A, 1B, 4, and 5. The procedure for model training may include a machine inference phase 1406. In some embodiments, the machine inference phase 1406 includes a step 1408 in which the UE 1402 and the network 1404 agree on the initial models and/or parameters. The machine inference phase 1406 also includes a step 1410 in which the UE 1402 transmits compressed CSI to the network 1404. After the machine inference phase 1406, at a step 1412, the network 1404 determines that the current models are not feasible for CSI generation and/or CSI reconstruction. Based on the determination, the network 1404 sends a request for new models to the UE 1402. At a step 1414, the UE 1402 trains the new models using datasets that are partially or fully different from the datasets used for training the current models. At a step 1416, the UE 1402 sends the trained new models to the network 1404 for CSI reconstruction. The UE 1402 also generates updated compressed CSI using the received new models. At a step 1418, the UE 1402 transmits the generated updated compressed CSI to the network 1404 for CSI reconstruction. In some embodiments, the models trained by the UE 1402 are AI/ML based models.

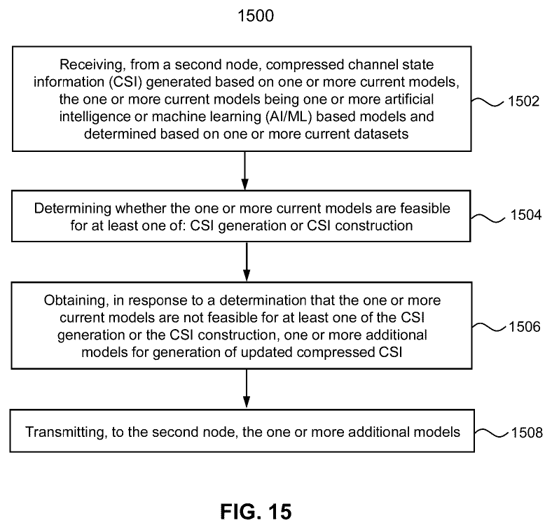

FIG. 15 is a schematic diagram illustrating a method for a first node for a communication, consistent with some embodiments of the present disclosure. The first node may be a network node, such as the base station 604 of FIG. 6, the base station 704 of FIG. 7, the base station 804 of FIG. 8, the base station 904 of FIG. 9, or the base station 1004 of FIG. 10. Referring to FIG. 15, a method 1500 includes a step 1502 of receiving, from a second node, compressed CSI generated based on one or more current models, the one or more current models being one or more AI/ML based models and determined based on one or more current datasets. The second node may be a UE, such as the UE 602 of FIG. 6, the UE 702 of FIG. 7, the UE 802 of FIG. 8, the UE 902 of FIG. 9, or the UE 1002 of FIG. 10. In some embodiments, before the step 1502, at an initial stage, the first node may identify at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part. In some embodiments, at the initial stage, the one or more initial structures of the model for the AI/ML based CSI generation part and the one or more initial structures of the model for the AI/ML based CSI reconstruction part are provided by a standard, such as the 3GPP standard.

In some embodiments, the AI/ML based CSI generation part is an encoder to be used by the second node, and the AI/ML based CSI reconstruction part is a decoder to be used by the first node. In some embodiments, the encoder and the decoder are an encoder and a decoder of an autoencoder, such as the autoencoder 200 of FIG. 2, or the autoencoder 300 of FIG. 3. In some embodiments, the autoencoder has a structure in which the encoder and the decoder are symmetric. In some embodiments, at least one structure of the encoder may include at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes. In some embodiments, at least one structure of the decoder may include at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes. The first node may further determine the one or more current models using one or more current datasets. The first node may determine the one or more current models based on communication with the second node.

The method 1500 includes a step 1504 of determining whether the one or more current models are feasible for at least one of: CSI generation or CSI reconstruction. For example, the first node may determine whether the one or more current models are feasible for the CSI generation and/or the CSI reconstruction, based on at least one of: (1) a deviation of one or more statistics of the received compressed CSI from one or more statistics of compressed CSI in a model training exceeding a first threshold, or (2) a deviation of one or more statistics of reconstructed channel from one or more statistics of datasets in the model training.

The method 1500 includes a step 1506 of obtaining, in response to a determination that the one or more current models are not feasible for at least one of the CSI generation or the CSI construction, one or more additional models for generation of updated compressed CSI. For example, in some embodiments, as shown in the method 600 of FIG. 6, the first node obtains the one or more additional models by training the one or more additional models using one or more additional datasets that are different from the one or more current datasets, in response to a determination that the one or more current models are not feasible for the CSI generation and/or the CSI reconstruction. The one or more additional datasets may be installed or downloaded at the first node.

In some embodiments, the first node obtains the one or more additional models from a third node. For example, in response to a determination that the one or more current models are not feasible for the CSI generation and/or the CSI reconstruction, the first node may transmit, to a third node, a request for one or more additional models, and receives the one or more additional models from the third node. In some embodiments, the third node may be a core network, such as the core network 706 of FIG. 7. The third node may also be a network management platform for service, management and orchestration (SMO) or operations, administration and management (OAM). In some embodiments, the third node may be a non-serving base station, such as the base station 1006 of FIG. 10. In this case, the first node may transmit the request for the one or more additional models to the base station through a node-to-node interface. After transmission of the request to the base station, the first node may receive the one or more additional models from the base station through the node-to-node interface. An example of such a node-to-node interface is Xn interface.

In some embodiments, the first node obtains the one or more additional models by obtaining one or more additional datasets from the third node and training the one or more additional models using the one or more additional datasets. The one or more additional datasets are datasets that are partially or fully different from the datasets used for training the one or more current models. For example, in response to a determination that the one or more current models are not feasible for the CSI generation and/or the CSI reconstruction, the first node may transmit, to a third node, a request for one or more additional datasets, and receive the one or more additional datasets from the third node. In some embodiments, the third node may be a core network, such as the core network 806 of FIG. 8. In some embodiments, the third node may be a non-serving base station, such as the base station 906 of FIG. 9. In this case, the first node may transmit the request for the one or more additional datasets to the base station through a node-to-node interface. After transmission the request to the base station, the first node may receive the one or more additional datasets from the base station through the node-to-node interface. An example of such a node-to-node interface is Xn interface. After receiving the one or more additional datasets, the first node may further train the one or more additional models using the one or more additional datasets. In some embodiments, the third node may be a network management platform.

The method 1500 includes a step 1508 of transmitting, to the second node, the one or more additional models. For example, as shown in the step 614 of FIG. 6, the step 718 of FIG. 7, the step 820 of FIG. 8, the step 920 of FIG. 9, or the step 1018 of FIG. 10, the first node (e.g., a base station) sends the new models to the second node (e.g., a UE). In some embodiments, after transmission of the one or more additional models to the second node, the first node may receive, from the second node, updated compressed CSI generated by the second node based on the one or more additional models, for example, as shown in the step 616 of FIG. 6, the step 720 of FIG. 7, the step 822 of FIG. 8, the step 922 of FIG. 9, or the step 1020 of FIG. 10. In some embodiments, after receiving the updated compressed CSI, the first node may reconstruct, using the updated compressed CSI, low dimensional information of a channel via a decoding process and a dequantization process.

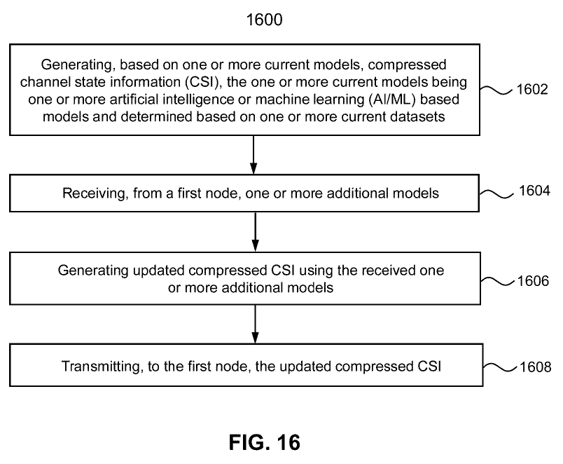

FIG. 16 is a schematic diagram illustrating a method for a second node for a communication, consistent with some embodiments of the present disclosure. The second node may be a UE, such as the UE 602 of FIG. 6, the UE 702 of FIG. 7, the UE 802 of FIG. 8, the UE 902 of FIG. 9, or the UE 1002 of FIG. 10. Referring to FIG. 16, a method 1600 includes a step 1602 of generating, based on one or more current models, compressed CSI, the one or more current models being one or more AI/ML based models and determined based on one or more current datasets. In some embodiments, before the step 1602, at an initial stage, the second node may identify at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

In some embodiments, the AI/ML based CSI generation part is an encoder to be used by the second node, and the AI/ML based CSI reconstruction part is a decoder to be used by the first node. The encoder and the decoder may be an encoder and a decoder of an autoencoder, respectively, such as the autoencoder 200 of FIG. 2 or the autoencoder 300 of FIG. 3. In some embodiments, the autoencoder has a sandwich structure in which the encoder and the decoder are symmetric. In some embodiments, at least one structure of the encoder may include at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes. In some embodiments, at least one structure of the decoder may include at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

In some embodiments, the second node may determine, for example, based on a communication with the first node, the one or more current models using the one or more current datasets. The first node may be a network node, such as the base station 604 of FIG. 6, the base station 704 of FIG. 7, the base station 804 of FIG. 8, the base station 904 of FIG. 9, or the base station 1004 of FIG. 10.

The method 1600 includes a step 1604 of receiving, from the first node, one or more additional models. The one or more additional models may be trained by the first node or received by the first node from a third node, in response to a determination that the one or more current models are not feasible for the CSI generation and/or the CSI reconstruction. For example, the third node may be a core network or a non-serving base station.

The method 1600 includes a step 1606 of generating updated compressed CSI using the received one or more additional models. For example, the second node may include an encoder of an autoencoder and generates the updated compressed CSI using the one or more additional models.

The method 1600 includes a step 1608 of transmitting, to the first node, the updated compressed CSI. For example, the second node sends the updated compressed CSI to the first node so that the first node may reconstruct the CSI.

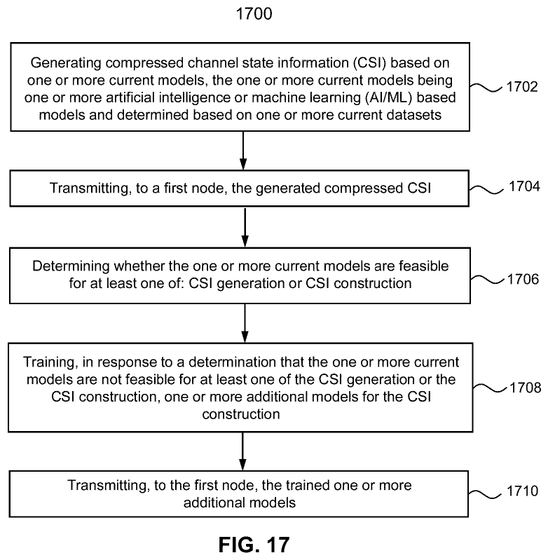

FIG. 17 is a schematic diagram illustrating a method for a second node for a communication, consistent with some embodiments of the present disclosure. The second node may be a UE, such as the UE 1102 of FIG. 11, or the UE 1202 of FIG. 12. Referring to FIG. 17, a method 1700 includes a step 1702 of generating compressed CSI based on one or more current models, the one or more current models being one or more AI/ML based models and determined based on one or more current datasets. In some embodiments, before the step 1702, the second node may identify at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part. In some embodiments, the AI/ML based CSI generation part is an encoder to be used by the second node, and the AI/ML based CSI reconstruction part is a decoder to be used by the first node. In some embodiments, the encoder and the decoder may be an encoder and a decoder of an autoencoder, respectively, such as the autoencoder 200 of FIG. 2, or the autoencoder 300 of FIG. 3. In some embodiments, the autoencoder may have a sandwich structure in which the encoder and the decoder are symmetric. In some embodiments, at least one structure of the encoder may include at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes. In some embodiments, at least one structure of the decoder may include at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

In some embodiments, the second node may determine the one or more current models using the one or more current datasets, for example, based on a communication with a first node. The first node may be a network node, such as the base station 1104 of FIG. 11, or the network 1204 of FIG. 12.

The method 1700 includes a step 1704 of transmitting, to the first node, the generated compressed CSI. For example, as shown in the step 1110 of FIG. 11 and the step 1210 of FIG. 12, the second node may transmit the compressed CSI to the first node.

The method 1700 includes a step 1706 of determining whether the one or more current models are feasible for the CSI generation and/or CSI construction. In some embodiments, the second node may determine whether the one or more current models are feasible for the CSI generation and/or the CSI construction based on at least one of: (1) a deviation of one or more statistics of the received compressed CSI from one or more statistics of compressed CSI in a model training exceeding a first threshold; or (2) a deviation of one or more statistics of reconstructed channel from one or more statistics of datasets in the model training.

The method 1700 includes a step 1708 of training, in response to a determination that the one or more current models are not feasible for the CSI generation and/or the CSI construction, one or more additional models for the CSI construction. For example, as shown in the step 1112 of FIG. 11 or the step 1216 of FIG. 12, the second node (e.g., a UE) trains the one or more additional models. In some embodiments, as shown in FIG. 11, the second node may train the one or more additional models using one or more additional datasets in the second node. The one or more additional datasets of the second node may be installed or downloaded at the second node. The one or more additional datasets are partially or fully different from the datasets used for determining the current models. In some embodiments, as shown in FIG. 12, the second node may train the one or more additional models using one or more additional datasets received from the first node. For example, in response to a determination that the one or more current models are not feasible for the CSI generation and/or the CSI construction, the second node may transmit a request for one or more additional datasets to the first node, receive the one or more additional datasets from the first node after the transmission of the request, and train the one or more additional models using the received one or more additional datasets.

The method 1700 includes a step 1710 of transmitting, to the first node, the trained one or more additional models. For example, as shown in the step 1114 of FIG. 11 or the step 1218 of FIG. 12, the second node (e.g., a UE) sends the trained one or more additional models to the first node (e.g., a base station). In some embodiments, the second node also generates updated compressed CSI based on the one or more additional models and sends the updated compressed CSI to the first node for CSI reconstruction.

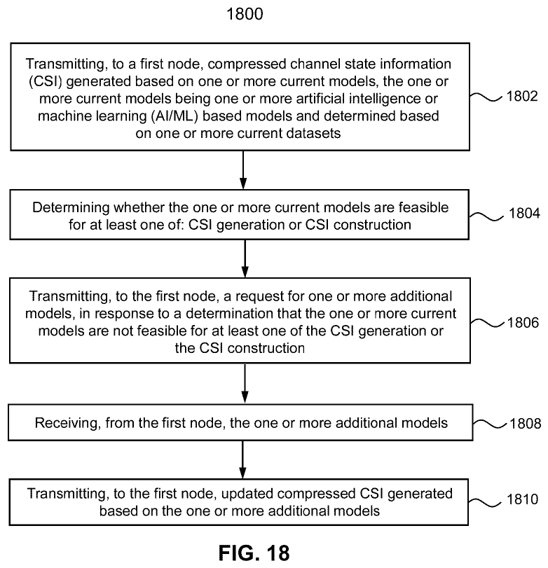

FIG. 18 is a schematic diagram illustrating a method for a second node for a communication, consistent with some embodiments of the present disclosure. The second node may be a UE, such as the UE 1302 of FIG. 13. Referring to FIG. 18, a method 1800 includes a step 1802 of transmitting, to a first node, compressed CSI generated based on one or more current models, the one or more current models being one or more AI/ML based models and determined based on one or more current datasets. In some embodiments, before the step 1302, at an initial stage, the second node may identify at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part. In some embodiments, the AI/ML based CSI generation part is an encoder to be used by the second node, and the AI/ML based CSI reconstruction part is a decoder to be used by the first node. The encoder and the decoder may be an encoder and a decoder of an autoencoder, respectively, such as the autoencoder 200 of FIG. 2, or the autoencoder 300 of FIG. 3. In some embodiments, the autoencoder may have a sandwich structure in which the encoder and the decoder are symmetric. In some embodiments, at least one structure of the encoder may include at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes. In some embodiments, at least one structure of the decoder may include at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

In some embodiments, the second node may determine the one or more current models using the one or more current datasets, for example, based on a communication with a first node. The first node may be a network node, such as the network 1304 of FIG. 13.

The method 1800 includes a step 1804 of determining whether the one or more current models are feasible for at least one of: CSI generation or CSI construction. In some embodiments, the second node may determine whether the one or more current models are feasible for the CSI generation and/or the CSI construction based on at least one of: (1) a deviation of one or more statistics of the received compressed CSI from one or more statistics of compressed CSI in a model training exceeding a first threshold; or (2) a deviation of one or more statistics of reconstructed channel from one or more statistics of datasets in the model training.

The method 1800 includes a step 1806 of transmitting, to the first node, a request for one or more additional models, in response to a determination that the one or more current models are not feasible for the CSI generation and/or the CSI construction. For example, as shown in the step 1312 of FIG. 13, the second node (e.g., a UE) sends a request for one or more additional (new) models to the first node (e.g., a network).

The method 1800 includes a step 1808 of receiving, from the first node, the one or more additional models. For example, as shown in the steps 1314 and 1316 of FIG. 13, the first node (e.g., network) trains the new models and sends the trained new models for CSI generation to the second node (e.g., a UE).

The method 1800 includes a step 1810 of transmitting, to the first node, updated compressed CSI generated based on the one or more additional models. For example, as shown in the step 1318 of FIG. 13, the second node generates updated compressed CSI based on the one or more additional models and sends the updated compressed CSI to the first node.

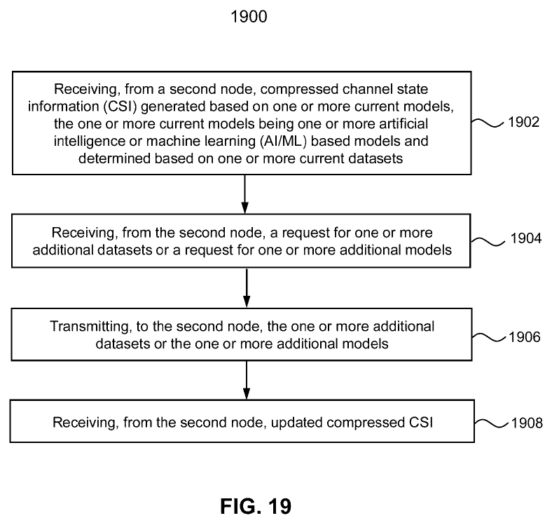

FIG. 19 is a schematic diagram illustrating a method for a first node for a communication, consistent with some embodiments of the present disclosure. The first node may be a network node, such as the network 1304 of FIG. 13. Referring to FIG. 19, a method 1900 includes a step 1902 of receiving, from a second node, compressed CSI generated based on one or more current models, the one or more current models being one or more AI/ML based models and determined based on one or more current datasets. The second node may be a UE, such as the UE 1302 of FIG. 13. In some embodiments, the second node may determine the one or more current models using the one or more current datasets, for example, based on a communication with a first node.

The method 1900 includes a step 1904 of receiving, from the second node, a request for one or more additional datasets or a request for one or more additional models. In some embodiments, for example, as shown in the step 1312 of FIG. 13, the first node (e.g., a network) receives a request for one or more additional (new) models from the second node (e.g., a UE). In some embodiments, for example, as shown in the step 1212 of FIG. 12, the first node (e.g., a network) receives a request for one or more additional datasets from the second node (e.g., a UE). The one or more additional datasets are one or more datasets that are partially or fully different from the datasets used for determining the one or more current models.

The method 1900 includes a step 1906 of transmitting, to the second node, the one or more additional datasets or the one or more additional models. In some embodiments, for example, as shown in the step 1316 of FIG. 13, the first node (e.g., a network) trains the one or more additional models and sends the trained one or more additional models to the second node (e.g., a UE). In some embodiments, for example, as shown in FIG. 12, the first node (e.g., a network) transmits the one or more additional datasets to the second node (e.g., a UE) so that the second node can train the one or more additional models using the one or more additional datasets.

The method 1900 includes a step 1908 of receiving, from the second node, updated compressed CSI. For example, as shown in the step 1220 of FIG. 12 or the step 1318 of FIG. 13, the first node (e.g., network) receives the updated compressed CSI from the second node (e.g., a UE).

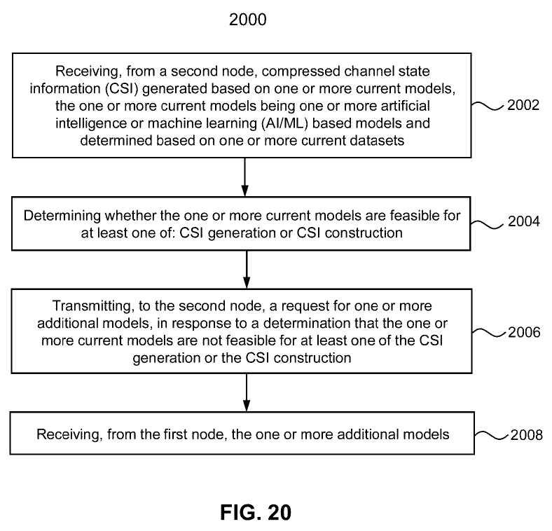

FIG. 20 is a schematic diagram illustrating a method for a first node for a communication, consistent with some embodiments of the present disclosure. The first node may be a network node, such as the network 1404 of FIG. 14. Referring to FIG. 20, a method 2000 includes a step 2002 of receiving, from a second node, compressed CSI generated based on one or more current models, the one or more current models being one or more AI/ML based models and determined based on one or more current datasets. The second node may be a UE, such as the UE 1402 of FIG. 14. In some embodiments, the first node may determine the one or more current models using the one or more current datasets for example, based on a communication with the second node.

The method 2000 includes a step 2004 of determining whether the one or more current models are feasible for at least one of: CSI generation or CSI construction. For example, the first node may determine whether the one or more current models are feasible for the CSI generation and/or the CSI construction based on at least one of: (1) a deviation of one or more statistics of the received compressed CSI from one or more statistics of compressed CSI in a model training exceeding a first threshold; or (2) a deviation of one or more statistics of reconstructed channel from one or more statistics of datasets in the model training.

The method 2000 includes a step 2006 of transmitting, to the second node, a request for one or more additional models, in response to a determination that the one or more current models are not feasible for at least one of the CSI generation or the CSI construction. In some embodiments, for example, as shown in the step 1412 of FIG. 14, in response to a determination that the one or more current models are not feasible for the CSI generation and/or the CSI construction, the first node (e.g., a network) sends a request for one or more additional models to the second node (e.g., a UE). In some embodiments, the first node may further receive, from the second node, information indicating that the request for the one or more additional models is granted, and transmit, to the second node, one or more additional datasets to be used by the second node for generation of the one or more additional models.

The method 2000 includes a step 2008 of receiving, from the second node, the one or more additional models. For example, as shown in the steps 1414 and 1416 of FIG. 14, the first node (e.g., network) receives the one or more additional models trained by the second node (e.g., a UE).

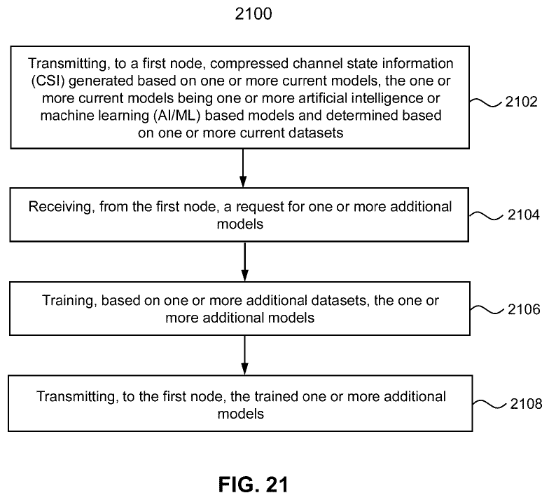

FIG. 21 is a schematic diagram illustrating a method for a second node for a communication, consistent with some embodiments of the present disclosure. The second node may be a UE, such as the UE 1402 of FIG. 14. Referring to FIG. 21, a method 2100 includes a step 2102 of transmitting, to a first node, compressed CSI generated based on one or more current models, the one or more current models being one or more AI/ML based models and determined based on one or more current datasets. The first node may be a network node, such as the network 1404 of FIG. 14.

In some embodiments, the second node may determine the one or more current models using the one or more current datasets, for example, based on a communication with the first node.

The method 2100 includes a step 2104 of receiving, from the first node, a request for one or more additional models. In some embodiments, after receiving the request, the second node may transmit, to the first node, an indication of granting the request. The second node may further receive, from the first node, the one or more additional datasets for training the one or more additional models.

The method 2100 includes a step 2106 of training, based on the one or more additional datasets, the one or more additional models. In some embodiments, for example, as shown in the step 1414 of FIG. 14, the second node (e.g., a UE) trains the one or more additional models.

The method 2100 includes a step 2108 of transmitting, to the first node, the trained one or more additional models. For example, as shown in the step 1416 of FIG. 14, the second node (e.g., a UE) transmits the trained one or more additional models to the first node (e.g., a network).

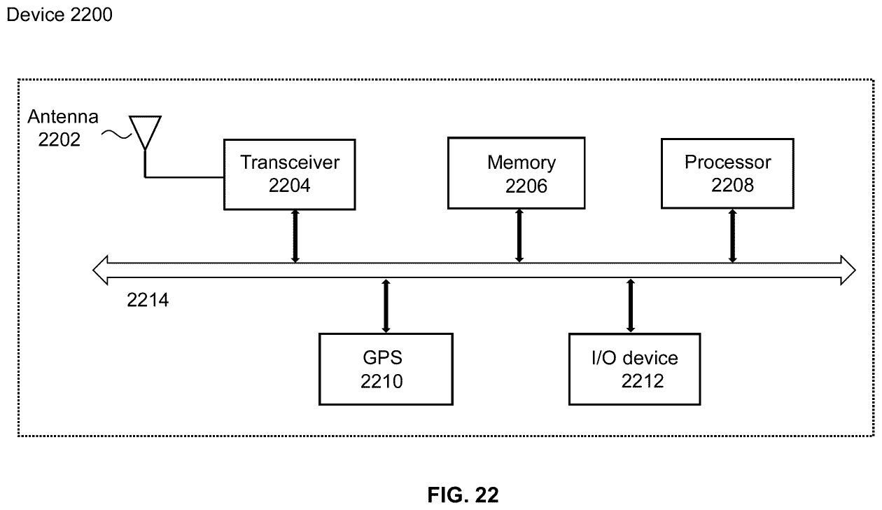

FIG. 22 is a block diagram of a device 2200, consistent with some embodiments of the present disclosure. In some embodiments, the device 2200 may be a UE. For example, the device 2200 may be the UE 402 of FIG. 4 or the UE 502 of FIG. 5 that includes an encoder of an autoencoder. For another example, the device 2200 may be the UE 602 of FIG. 6 or the UE 702 of FIG. 7, or the UE 802 of FIG. 8, or the UE 902 of FIG. 9, or the UE 1002 of FIG. 10, or the UE 1302 of FIG. 13 that receives trained new models from a network node and generates updated compressed CSI using the received new models. For another example, the device 2200 may be the UE 1102 of FIG. 11 or the UE 1202 of FIG. 12, or the UE 1402 of FIG. 14 that trains new models. The UE may take any form, including but not limited to, a vehicle, a component mounted in a vehicle, a road-side unit, a laptop computer, a wireless terminal including a mobile phone, a wireless handheld device, or wireless personal device, or any other form. In some embodiments, the device 2200 may be a network node. For example, the device 2200 may be the base station 404 of FIG. 4 or the network 504 of FIG. 5 that includes a decoder of an autoencoder. For another example, the device 2200 may be the base station 604 of FIG. 6 or the base station 704, or the base station 804 of FIG. 8, or the base station 904 of FIG. 9, or the base station 1004 of FIG. 10 that determines whether the current models are feasible or not for CSI generation and/or CSI construction. For another example, the device 2200 may be the network 1404 of FIG. 14 that sends a request for new models to a UE and receives the new models trained by the UE. In these embodiments, the device 2200 may take the form of a base station (or a component of a base station) or a core network or any other network node.

Referring to FIG. 22, the device 2200 may include antenna 2202 that may be used for transmission or reception of electromagnetic signals to/from one or more other devices (e.g., base stations or UEs). The antenna 2202 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 2202 may include multiple (e.g., tens or hundreds) antenna elements and may enable multi-antenna functions such as beamforming. In some embodiments, the antenna 2202 is a single antenna.

The device 2200 may include a transceiver 2204 that is coupled to the antenna 2202. The transceiver 2204 may be a wireless transceiver at the device 2200 and may communicate bi-directionally with other devices (e.g., base stations or UEs). For example, in some embodiments, the device 2200 is a UE and the transceiver 2204 may receive/transmit wireless signals from/to a base station via downlink/uplink communication. The transceiver 2204 may also receive/transmit wireless signals from/to another UE or road side unit via sidelink communication. The transceiver 2204 may include a modem to modulate the packets and provide the modulated packets to the antenna 2202 for transmission, and to demodulate packets received from the antenna 2202.

The device 2200 may include a memory 2206. The memory 2206 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 2206 may store information related to identities of the device 2200 and the signals and/or data received by the antenna 2202. The memory may also store an encoder and/or a decoder of an autoencoder. The memory may also store one or more learning models for AI/ML methods. The memory 2206 may also store post-processing signals and/or data. The memory 2206 may also store computer-readable program instructions, mathematical models, and algorithms that are used in signal processing in the transceiver 2204 and computations in a processor 2208 included in the device 2200. The memory 2206 may further store computer-readable program instructions for execution by the processor 2208 to operate the device 2200 to perform various functions described in this disclosure. In some examples, the memory 2206 may include a basic input/output system (BIOS) which may control basic hardware or software operation such as the interaction with peripheral components or devices. In some embodiments, the memory 2206 includes a learning model for UE and a learning model for base station.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second node, remote computing device may be connected to the first computing device through any type of network, including a local area network (LAN) or a wide area network (WAN).

The processor 2208 may include a hardware device with processing capabilities. The processor 2208 may include at least one of a general-purpose processor, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 2208 may be implemented using a combination of devices (e.g., a combination of a DSP and a microprocessor, multiple microprocessors, one or more microprocessors in conjunction with a DSP core, or any other such configuration). The processor 2208 may receive, from transceiver 2204, downlink/uplink signals or sidelink signals and further process the signals. The processor 2208 may also receive, from transceiver 2204, data packets and further process the packets. In some embodiments, the processor 2208 may be configured to operate a memory using a memory controller. In some embodiments, a memory controller may be integrated into the processor 2208. The processor 2208 may be configured to execute computer-readable instructions stored in a memory (e.g., the memory 2206) to cause the device 2200 to perform various functions, such as, for example, one or more of the methods as shown in FIGS. 15-21.

The device 2200 may include a global positioning system (GPS) 2210. The GPS 2210 may be used for enabling location-based services or other services based on a geographical position of the device 2200 and/or synchronization among Ues. The GPS 2210 may receive global navigation satellite systems (GNSS) signals from a single satellite or a plurality of satellite signals via the antenna 2202 and provide a geographical position of the device 2200. In some embodiments, the GPS 2210 is omitted. In some embodiments, a timer is included.

The device 2200 may include an input/output (I/O) device 2212 that may be used to communicate a result of signal processing and computation to a user or another device. The I/O device 2212 may include a user interface including a display and an input device to transmit a user command to the processor 2208. The display may be configured to display a status of signal reception at the device 2200, the data stored at the memory 2206, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The device 2200 may further include a machine interface 2214, such as an electrical bus that connects the transceiver 2204, the memory 2206, the processor 2208, the GPS 2210, and the I/O device 2212.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification, the terms “comprise,” “include,” or “contain” may be used interchangeably and have the same meaning and are to be construed as inclusive and open-ended. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance or an example.” By reading this disclosure, including the description of the embodiments and the drawings, it will be appreciated by a person of ordinary skills in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range. Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives, and variations in the details, materials, and arrangements of the parts which have been described and illustrated in order to explain the nature of described embodiments may be made by those skilled in the art without departing from the scope. Accordingly, the following claims embrace all such alternatives, modifications, and variations that fall within the terms of the claims.

Clause 1: A first node for a communication, the first node comprising:
a memory storing an instruction; and
a processor configured to execute the instruction stored in the memory to:
   receive, from a second node, compressed channel state information (CSI) generated based on one or more current models, the one or more current models being one or more artificial intelligence or machine learning (AI/ML) based models and determined based on one or more current datasets;
   determine whether the one or more current models are feasible for at least one of: CSI generation or CSI reconstruction;
   obtain, in response to a determination that the one or more current models are not feasible for at least one of the CSI generation or the CSI reconstruction, one or more additional models for generation of updated compressed CSI; and
   transmit, to the second node, the one or more additional models.

Clause 2: The first node of clause 1, wherein the first node is a base station, and the second node is a user equipment (UE).

Clause 3: The first node of clause 1, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

Clause 4: The first node of clause 3, wherein, at the initial stage, the one or more initial structures of the model for the AI/ML based CSI generation part and the one or more initial structures of the model for the AI/ML based CSI reconstruction part are provided by a standard.

Clause 5: The first node of clause 3, wherein the AI/ML based CSI generation part is an encoder to be used by the second node, and the AI/ML based CSI reconstruction part is a decoder to be used by the first node.

Clause 6: The first node of clause 1, wherein the processor is further configured to execute the instruction stored in the memory to:
determine, based on a communication with the second node, the one or more current models using the one or more current datasets.

Clause 7: The first node of clause 1, wherein the processor is further configured to execute the instruction stored in the memory to:
receive, from the second node, the updated compressed CSI generated based on the one or more additional models.

Clause 8: The first node of clause 1, wherein the processor is further configured to execute the instruction stored in the memory to:
obtain the one or more additional models by training the one or more additional models using one or more additional datasets that are different from the one or more current datasets, in response to a determination that the one or more current models are not feasible for at least one of: the CSI generation or the CSI reconstruction.

Clause 9: The first node of clause 8, wherein the one or more additional datasets are installed or downloaded at the first node.

Clause 10: The first node of clause 1, wherein the processor is further configured to execute the instruction stored in the memory to:
transmit, to a third node, a request for the one or more additional models, in response to a determination that the one or more current models are not feasible for at least one of: the CSI generation or the CSI reconstruction; and
receive, from the third node, the one or more additional models.

Clause 11: The first node of clause 10, wherein the third node is a core network or a network management platform for service, management and orchestration (SMO) or operations, administration and management (OAM).

Clause 12: The first node of clause 10, wherein the third node is a base station, and the processor is further configured to execute the instruction stored in the memory to transmit the request to the base station through a node-to-note interface.

Clause 13: The first node of clause 10, wherein the third node is a base station, and the processor is further configured to execute the instruction stored in the memory to receive the one or more additional models through a node-to-note interface.

Clause 14: The first node of clause 1, wherein the processor is further configured to execute the instruction stored in the memory to:
transmit, to a third node, a request for one or more additional datasets, in response to a determination that the one or more current models are not feasible for at least one of the CSI generation or the CSI reconstruction; and receive, from the third node, the one or more additional datasets.

Clause 15: The first node of clause 14, wherein the processor is further configured to execute the instruction stored in the memory to:
train the one or more additional models using the one or more additional datasets.

Clause 16: The first node of clause 14, wherein the third node is a core network or a non-serving base station or a network management platform.

Clause 17: The first node of clause 5, wherein the encoder and the decoder are an encoder and a decoder of an autoencoder, respectively.

Clause 18: The first node of clause 5, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes.

Clause 19: The first node of clause 5, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes.

Clause 20: The first node of clause 17, wherein the autoencoder has a structure in which the encoder and the decoder are symmetric.

Clause 21: The first node of clause 7, wherein the processor is further configured to execute the instruction stored in the memory to:
reconstruct, using the updated compressed CSI, low dimensional information of a channel via a decoding process and a dequantization process.

Clause 22: The first node of clause 1, wherein determining whether the one or more current models are feasible for at least one of the CSI generation or the CSI reconstruction, is based on at least one of: (1) a deviation of one or more statistics of the received compressed CSI from one or more statistics of compressed CSI in a model training exceeding a first threshold; or (2) a deviation of one or more statistics of reconstructed channel from one or more statistics of datasets in the model training.

Clause 23: A second node for a communication, the second node comprising:
a memory storing an instruction; and
a processor configured to execute the instruction stored in the memory to:
   generate, based on one or more current models, compressed channel state information (CSI), the one or more current models being one or more artificial intelligence or machine learning (AI/ML) based models and determined based on one or more current datasets;
   receive, from a first node, one or more additional models;
   generate updated compressed CSI using the received one or more additional models; and
   transmit, to the first node, the updated compressed CSI.

Clause 24: The second node of clause 23, wherein the second node is a user equipment (UE), and the first node is a base station.

Clause 25: The second node of clause 22, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

Clause 26: The second node of clause 25, wherein the AI/ML based CSI generation part is an encoder to be used by the second node, and the AI/ML based CSI reconstruction part is a decoder to be used by the first node.

Clause 27: The second node of clause 23, wherein the processor is further configured to execute the instruction stored in the memory to:
determine, based on a communication with the first node, the one or more current models using the one or more current datasets.

Clause 28: The second node of clause 26, wherein the encoder and the decoder are an encoder and a decoder of an autoencoder, respectively.

Clause 29: The second node of clause 26, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 30: The second node of clause 26, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 31: The second node of clause 28, wherein the autoencoder has a structure in which the encoder and the decoder are symmetric.

Clause 32: The second node of clause 23, wherein the processor is further configured to execute the instruction stored in the memory to:
transfer low dimensional information to a bit stream of the updated compressed CSI via a coding process and a quantization process.

Clause 33: A second node for a communication, the second node comprising:
a memory storing an instruction; and
a processor configured to execute the instruction stored in the memory to:
   generate compressed channel state information (CSI) based on one or more current models, the one or more current models being one or more artificial intelligence or machine learning (AI/ML) based models and determined based on one or more current datasets;
   transmit, to a first node, the generated compressed CSI;
   determine whether the one or more current models are feasible for at least one of: CSI generation or CSI reconstruction;
   train, in response to a determination that the one or more current models are not feasible for at least one of the CSI generation or the CSI reconstruction, one or more additional models for the CSI reconstruction; and
   transmit, to the first node, the trained one or more additional models.

Clause 34: The second node of clause 33, wherein the second node is a user equipment (UE), and the first node is a base station.

Clause 35: The second node of clause 32, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

Clause 36: The second node of clause 35, wherein the AI/ML based CSI generation part is an encoder to be used by the second node, and the AI/ML based CSI reconstruction part is a decoder to be used by the first node.

Clause 37: The second node of clause 33, wherein the processor is further configured to execute the instruction stored in the memory to:
determine, based on a communication with the first node, the one or more current models using the one or more current datasets.

Clause 38: The second node of clause 33, wherein the processor is further configured to execute the instruction stored in the memory to:
generate updated compressed CSI based on the one or more additional models.

Clause 39: The second node of clause 33, wherein the processor is further configured to execute the instruction stored in the memory to:
train the one or more additional models using one or more additional datasets that are different from the one or more current datasets, in response to a determination that the one or more current models are not feasible for at least one of the CSI generation or the CSI reconstruction.

Clause 40: The second node of clause 39, wherein the one or more additional datasets of the second node are installed or downloaded at the second node.

Clause 41: The second node of clause 33, wherein the processor is further configured to execute the instruction stored in the memory to:
transmit, to the first node, a request for one or more additional datasets, in response to a determination that the one or more current models are not feasible for at least one of the CSI generation or the CSI reconstruction;
receive, from the first node, the one or more additional datasets; and
train the one or more additional models using the one or more additional datasets.

Clause 42: The second node of clause 36, wherein the encoder and the decoder are an encoder and a decoder of an autoencoder, respectively.

Clause 43: The second node of clause 36, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 44: The second node of clause 36, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 45: The second node of clause 42, wherein the autoencoder has a structure in which the encoder and the decoder are symmetric.

Clause 46: The second node of clause 33, wherein determining whether the one or more current models are feasible for at least one of the CSI generation or the CSI reconstruction, is based on at least one of: (1) a deviation of one or more statistics of the generated compressed CSI from one or more statistics of compressed CSI in a model training exceeding a threshold, or (2) a deviation of one or more statistics of reconstructed channel from one or more statistics of datasets in the model training.

Clause 47: A second node for a communication, the second node comprising:
a memory storing an instruction; and
a processor configured to execute the instruction stored in the memory to:
   transmit, to a first node, compressed channel state information (CSI) generated based on one or more current models, the one or more current models being one or more artificial intelligence or machine learning (AI/ML) based models and determined based on one or more current datasets;
   determine whether the one or more current models are feasible for at least one of: CSI generation or CSI reconstruction;
   transmit, to the first node, a request for one or more additional models, in response to a determination that the one or more current models are not feasible for at least one of the CSI generation or the CSI reconstruction;
   receive, from the first node, the one or more additional models; and
   transmit, to the first node, updated compressed CSI generated based on the one or more additional models.

Clause 48: The second node of clause 47, wherein the second node is a user equipment (UE), and the first node is a base station.

Clause 49: The second node of clause 47, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

Clause 50: The second node of clause 49, wherein the AI/ML based CSI generation part is an encoder to be used by the second node, and the AI/ML based CSI reconstruction part is a decoder to be used by the first node.

Clause 51: The second node of clause 47, wherein the processor is further configured to execute the instruction stored in the memory to:
determine, based on a communication with the first node, the one or more current models using the one or more current datasets.

Clause 52: The second node of clause 50, wherein the encoder and the decoder are an encoder and a decoder of an autoencoder, respectively.

Clause 53: The second node of clause 50, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 54: The second node of clause 50, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

Clause 55: A first node for a communication, the first node comprising:
a memory storing an instruction; and
a processor configured to execute the instruction stored in the memory to:
   receive, from a second node, compressed channel state information (CSI) generated based on one or more current models, the one or more current models being one or more artificial intelligence or machine learning (AI/ML) based models and determined based on one or more current datasets;
   receive, from the second node, a request for one or more additional datasets or a request for one or more additional models;
   transmit, to the second node, the one or more additional datasets or the one or more additional models; and
   receive, from the second node, updated compressed CSI.

Clause 56: The first node of clause 55, wherein the first node is a base station, and the second node is a user equipment (UE).

Clause 57: A first node for a communication, the first node comprising:
a memory storing an instruction; and
a processor configured to execute the instruction stored in the memory to:
   receive, from a second node, compressed channel state information (CSI) generated based on one or more current models, the one or more current models being one or more artificial intelligence or machine learning (AI/ML) based models and determined based on one or more current datasets;
   determine whether the one or more current models are feasible for at least one of: CSI generation or CSI reconstruction;
   transmit, to the second node, a request for one or more additional models, in response to a determination that the one or more current models are not feasible for at least one of the CSI generation or the CSI reconstruction; and
   receive, from the second node, the one or more additional models.

Clause 58: The first node of clause 57, wherein processor is further configured to execute the instruction stored in the memory to:
receive, from the second node, information indicating that the request for the one or more additional models is granted; and
transmit, to the second node, one or more additional datasets to be used by the second node for generation of the one or more additional models.

Clause 59: A second node for a communication, the second node comprising:
a memory storing an instruction; and
a processor configured to execute the instruction stored in the memory to:
   transmit, to a first node, compressed channel state information (CSI) generated based on one or more current models, the one or more current models being one or more artificial intelligence or machine learning (AI/ML) based models and determined based on one or more current datasets;
   receive, from the first node, a request for one or more additional models;
   train, based on one or more additional datasets, the one or more additional models; and
   transmit, to the first node, the trained one or more additional models.

Clause 60: The second node of clause 59, wherein processor is further configured to execute the instruction stored in the memory to:
transmit, to the first node, an indication of granting the request; and
receive, from the first node, the one or more additional datasets for generation of the one or more additional models.

Clause 61: A method for a first node for a communication, the method comprising:
receiving, from a second node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
obtaining, in response to a determination that the one or more current models are not feasible for at least one of the CSI generation or the CSI reconstruction, one or more additional models for generation of updated compressed CSI; and
transmitting, to the second node, the one or more additional models.

Clause 62: A method for a second node for a communication, the method comprising:
generating, based on one or more current models, compressed channel state information (CSI), the one or more current models being one or more artificial intelligence or machine learning (AI/ML) based models and determined based on one or more current datasets;
receiving, from a first node, one or more additional models;
generating updated compressed CSI using the received one or more additional models; and
transmitting, to the first node, the updated compressed CSI.

Clause 63: A method for a second node for a communication, the method comprising:
generating compressed channel state information (CSI) based on one or more current models, the one or more current models being one or more artificial intelligence or machine learning (AI/ML) based models and determined based on one or more current datasets;
transmitting, to a first node, the generated compressed CSI;
determining whether the one or more current models are feasible for at least one of: CSI generation or CSI reconstruction;
training, in response to a determination that the one or more current models are not feasible for at least one of the CSI generation or the CSI reconstruction, one or more additional models for the CSI reconstruction; and
transmitting, to the first node, the trained one or more additional models.

Clause 64: A method for a second node for a communication, the method comprising:
transmitting, to a first node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
transmitting, to the first node, a request for one or more additional models, in response to a determination that the one or more current models are not feasible for at least one of the CSI generation or the CSI reconstruction;
receiving, from the first node, the one or more additional models; and
transmitting, to the first node, updated compressed CSI generated based on the one or more additional models.

Clause 65: A method for a first node for a communication, the method comprising:
receiving, from a second node, compressed channel state information (CSI) generated based on one or more current models, the one or more current models being one or more artificial intelligence or machine learning (AI/ML) based models and determined based on one or more current datasets;
receiving, from the second node, a request for one or more additional datasets or a request for one or more additional models;
transmitting, to the second node, the one or more additional datasets or the one or more additional models; and
receiving, from the second node, updated compressed CSI.

Clause 66: A method for a first node for a communication, the method comprising:
receiving, from a second node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
transmitting, to the second node, a request for one or more additional models, in response to a determination that the one or more current models are not feasible for at least one of the CSI generation or the CSI reconstruction; and
receiving, from the first node, the one or more additional models.

Clause 67: A method for a second node for a communication, the method comprising:
transmitting, to a first node, compressed channel state information (CSI) generated based on one or more current models, the one or more current models being one or more artificial intelligence or machine learning (AI/ML) based models and determined based on one or more current datasets;
receiving, from the first node, a request for one or more additional models;
training, based on one or more additional datasets, the one or more additional models; and
transmitting, to the first node, the trained one or more additional models.

Clause 68: A non-transitory computer-readable medium storing instructions that are executable by one or more processors of a first node for communication, to perform a method, the method comprising:
receiving, from a second node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
obtaining, in response to a determination that the one or more current models are not feasible for at least one of the CSI generation or the CSI reconstruction, one or more additional models for generation of updated compressed CSI; and
transmitting, to the second node, the one or more additional model.

Clause 69: A non-transitory computer-readable medium storing instructions that are executable by one or more processors of a second node for a communication, to perform a method, the method comprising:
generating, based on one or more current models, compressed channel state information (CSI), the one or more current models being one or more artificial intelligence or machine learning (AI/ML) based models and determined based on one or more current datasets;
receiving, from a first node, one or more additional models;
generating updated compressed CSI using the received one or more additional models; and
transmitting, to the first node, the updated compressed CSI.

Clause 70: A non-transitory computer-readable medium storing instructions that are executable by one or more processors of a second node for a communication, to perform a method, the method comprising:
generating compressed channel state information (CSI) based on one or more current models, the one or more current models being one or more artificial intelligence or machine learning (AI/ML) based models and determined based on one or more current datasets;
transmitting, to a first node, the generated compressed CSI;
determining whether the one or more current models are feasible for at least one of: CSI generation or CSI reconstruction;
training, in response to a determination that the one or more current models are not feasible for at least one of the CSI generation or the CSI reconstruction, one or more additional models for the CSI reconstruction; and
transmitting, to the first node, the trained one or more additional models.

Clause 71: A non-transitory computer-readable medium storing instructions that are executable by one or more processors of a second node for a communication, to perform a method, the method comprising:
transmitting, to a first node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
transmitting, to the first node, a request for one or more additional models, in response to a determination that the one or more current models are not feasible for at least one of the CSI generation or the CSI reconstruction;
receiving, from the first node, the one or more additional models; and
transmitting, to the first node, updated compressed CSI generated based on the one or more additional models.

Clause 72: A non-transitory computer-readable medium storing instructions that are executable by one or more processors of a first node for a communication, to perform a method, the method comprising:
receiving, from a second node, compressed channel state information (CSI) generated based on one or more current models, the one or more current models being one or more artificial intelligence or machine learning (AI/ML) based models and determined based on one or more current datasets;
receiving, from the second node, a request for one or more additional datasets or a request for one or more additional models;
transmitting, to the second node, the one or more additional datasets or the one or more additional models; and
receiving, from the second node, updated compressed CSI.

Clause 73: A non-transitory computer-readable medium storing instructions that are executable by one or more processors of a first node for a communication, to perform a method, the method comprising:
receiving, from a second node, compressed channel state information (CSI) generated based on one or more current models, the one or more current models being one or more artificial intelligence or machine learning (AI/ML) based models and determined based on one or more current datasets;
determining whether the one or more current models are feasible for at least one of: CSI generation or CSI reconstruction;
transmitting, to the second node, a request for one or more additional models, in response to a determination that the one or more current models are not feasible for at least one of the CSI generation or the CSI reconstruction; and
receiving, from the first node, the one or more additional models.

Clause 74: A non-transitory computer-readable medium storing instructions that are executable by one or more processors of a second node for a communication, to perform a method, the method comprising:
transmitting, to a first node, compressed channel state information (CSI) generated based on one or more current models, the one or more current models being one or more artificial intelligence or machine learning (AI/ML) based models and determined based on one or more current datasets;
receiving, from the first node, a request for one or more additional models;
training, based on one or more additional datasets, the one or more additional models; and
transmitting, to the first node, the trained one or more additional models.

1. A first node for a communication, the first node comprising:
a memory storing an instruction; and
a processor configured to execute the instruction stored in the memory to:
receive, from a second node, compressed channel state information (CSI) generated based on one or more current models, the one or more current models being one or more artificial intelligence or machine learning (AI/ML) based models and determined based on one or more current datasets;
determine whether the one or more current models are feasible for at least one of: CSI generation or CSI reconstruction;
obtain, in response to a determination that the one or more current models are not feasible for at least one of the CSI generation or the CSI reconstruction, one or more additional models for generation of updated compressed CSI, the one or more additional models being trained at the first node or another network node; and
transmit, to the second node, the one or more additional models.

2. The first node of claim 1, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

3. The first node of claim 2, wherein the AI/ML based CSI generation part is an encoder to be used by the second node, and the AI/ML based CSI reconstruction part is a decoder to be used by the first node.

4. The first node of claim 1, wherein the processor is further configured to execute the instruction stored in the memory to:
obtain the one or more additional models by training the one or more additional models using one or more additional datasets that are different from the one or more current datasets, in response to a determination that the one or more current models are not feasible for at least one of: the CSI generation or the CSI reconstruction.

5. The first node of claim 1, wherein the processor is further configured to execute the instruction stored in the memory to:
transmit, to a third node, a request for the one or more additional models, in response to a determination that the one or more current models are not feasible for at least one of: the CSI generation or the CSI reconstruction; and
receive, from the third node, the one or more additional models.

6. The first node of claim 1, wherein the processor is further configured to execute the instruction stored in the memory to:
transmit, to a third node, a request for one or more additional datasets, in response to a determination that the one or more current models are not feasible for at least one of the CSI generation or the CSI reconstruction; and
receive, from the third node, the one or more additional datasets.

7. The first node of claim 3, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes.

8. The first node of claim 3, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters of each of the plurality of neural nodes, or one or more loss functions of the plurality of neural nodes.

9. The first node of claim 1, wherein determining whether the one or more current models are feasible for at least one of the CSI generation or the CSI reconstruction, is based on at least one of: (1) a deviation of one or more statistics of the received compressed CSI from one or more statistics of compressed CSI in a model training exceeding a first threshold; or (2) a deviation of one or more statistics of reconstructed channel from one or more statistics of datasets in the model training.

10. A second node for a communication, the second node comprising:
a memory storing an instruction; and
a processor configured to execute the instruction stored in the memory to:
generate, based on one or more current models, compressed channel state information (CSI), the one or more current models being one or more artificial intelligence or machine learning (AI/ML) based models and determined based on one or more current datasets;
receive, from a first node, one or more additional models;
generate updated compressed CSI using the received one or more additional models, the one or more additional models being trained at the first node or another network node; and
transmit, to the first node, the updated compressed CSI.

11. The second node of claim 10, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

12. The second node of claim 11, wherein the AI/ML based CSI generation part is an encoder to be used by the second node, and the AI/ML based CSI reconstruction part is a decoder to be used by the first node.

13. The second node of claim 12, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

14. The second node of claim 12, wherein at least one structure of the decoder comprises at least one of: a plurality of layers of a plurality of neural nodes in the decoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

15. A second node for a communication, the second node comprising:
a memory storing an instruction; and
a processor configured to execute the instruction stored in the memory to:
generate compressed channel state information (CSI) based on one or more current models, the one or more current models being one or more artificial intelligence or machine learning (AI/ML) based models and determined based on one or more current datasets;
transmit, to a first node, the generated compressed CSI;
determine whether the one or more current models are feasible for at least one of: CSI generation or CSI reconstruction;
train, in response to a determination that the one or more current models are not feasible for at least one of the CSI generation or the CSI reconstruction, one or more additional models for the CSI reconstruction; and
transmit, to the first node, the trained one or more additional models.

16. The second node of claim 15, wherein the processor is further configured to execute the instruction stored in the memory to:
identify, at an initial stage, at least one of: one or more initial structures of a model for an AI/ML based CSI generation part to be used by the second node, one or more initial structures of a model for an AI/ML based CSI reconstruction part to be used by the first node, one or more initial parameters for the model for the AI/ML based CSI generation part, one or more weights for the model for the AI/ML based CSI generation part, one or more initial parameters for the model for the AI/ML based CSI reconstruction part, or one or more weights for the model for the AI/ML based CSI reconstruction part.

17. The second node of claim 16, wherein the AI/ML based CSI generation part is an encoder to be used by the second node, and the AI/ML based CSI reconstruction part is a decoder to be used by the first node.

18. The second node of claim 15, wherein the processor is further configured to execute the instruction stored in the memory to:
train the one or more additional models using one or more additional datasets that are different from the one or more current datasets, in response to a determination that the one or more current models are not feasible for at least one of the CSI generation or the CSI reconstruction.

19. The second node of claim 15, wherein the processor is further configured to execute the instruction stored in the memory to:
transmit, to the first node, a request for one or more additional datasets, in response to a determination that the one or more current models are not feasible for at least one of the CSI generation or the CSI reconstruction;
receive, from the first node, the one or more additional datasets; and
train the one or more additional models using the one or more additional datasets.

20. The second node of claim 17, wherein at least one structure of the encoder comprises at least one of: a plurality of layers of a plurality of neural nodes in the encoder, a number of neural nodes in each of the plurality of layers, one or more types of the plurality of layers, one or more connection architectures between the plurality of layers, one or more types of connections between the plurality of layers, one or more types of operations in each of the plurality of neural nodes, a weight of each of the plurality of neural nodes, one or more parameters for each of the plurality of neural nodes, or one or more loss functions of the plurality of neural nodes.

21-30. (canceled)
